(19) United States
(12) Patent Application Publication
(10) Pub. No.: US 2023/0419672 A1
(43) Pub. Date: Dec. 28, 2023

(54) CONFIGURABLE MODULAR DEVICES AND OTHER SYSTEMS AND METHODS

(71) Applicant: Deako, Inc., Seattle, WA (US)

(72) Inventors: Patrick Prendergast, Clinton, WA (US); Kirkwood Hines, Seattle, WA (US); Nathan Diehl, Seattle, WA (US); Derek Richardson, Seattle, WA (US); Stephen Bird, Seattle, WA (US); Nathan Weathers, Orting, WA (US)

(21) Appl. No.: 18/243,511

(22) Filed: Sep. 7, 2023

Related U.S. Application Data
(63) Continuation-in-part of application No. 18/209,245, filed on Jun. 13, 2023.
Application No. 18/209,245 is a continuation-in-part of application No. 18/123,669, filed on Mar. 20, 2023.
Application No. 18/123,669 is a continuation of application No. 17/738,822, filed on May 6, 2022, now Pat. No. 11,615,625.
Application No. 17/738,822 is a continuation of application No. 16/915,817, filed on Jun. 29, 2020, now Pat. No. 11,367,288.
Application No. 16/915,817 is a continuation of application No. 16/114,047, filed on Aug. 27, 2018, now Pat. No. 10,699,131.
Application No. 16/114,047 is a continuation of application No. 15/253,811, filed on Aug. 31, 2016, now Pat. No. 10,078,786.
Application No. 15/253,811 is a continuation-in-part of application No. 15/145,624, filed on May 3, 2016, now Pat. No. 10,069,235.
Application No. 15/145,624 is a continuation-in-part of application No. 15/074,915, filed on Mar. 18, 2016, now Pat. No. 10,063,002.
Application No. 16/114,047 is a continuation of application No. 15/253,815, filed on Aug. 31, 2016, now Pat. No. 10,153,113.
Application No. 15/253,815 is a continuation-in-part of application No. 15/074,915, filed on Mar. 18, 2016, now Pat. No. 10,063,002.
Application No. 15/074,915 is a continuation-in-part of application No. 15/145,624, filed on May 3, 2016, now Pat. No. 10,069,235.
Application No. 16/114,047 is a continuation of application No. 15/253,819, filed on Aug. 31, 2016, now abandoned.
Application No. 15/253,819 is a continuation-in-part of application No. 15/074,915, filed on Mar. 18, 2016, now Pat. No. 10,063,002.
Application No. 15/074,915 is a continuation-in-part of application No. 15/145,624, filed on May 3, 2016, now Pat. No. 10,069,235.
Application No. 16/114,047 is a continuation of application No. 15/145,624, filed on May 3, 2016, now Pat. No. 10,069,235.
Application No. 15/145,624 is a continuation of application No. 15/074,915, filed on Mar. 18, 2016, now Pat. No. 10,063,002.
Application No. 17/738,822 is a continuation of application No. 17/195,831, filed on Mar. 9, 2021.
Application No. 17/195,831 is a continuation of application No. 16/915,048, filed on Jun. 29, 2020, now Pat. No. 10,944,220.
Application No. 16/915,048 is a continuation of application No. 16/119,953, filed on Aug. 31, 2018, now Pat. No. 10,700,477.
(60) Provisional application No. 63/351,729, filed on Jun. 13, 2022.
(60) Provisional application No. 62/212,388, filed on Aug. 31, 2015.
(60) Provisional application No. 62/212,388, filed on Aug. 31, 2015.
(60) Provisional application No. 62/212,388, filed on Aug. 31, 2015.
(60) Provisional application No. 62/212,388, filed on Aug. 31, 2015.
(60) Provisional application No. 62/552,601, filed on Aug. 31, 2017.

(51) Int. Cl. G06V 20/52; G06F 3/01; H05B 47/19; G06V 40/13; G06V 40/20; H05B 47/105; H01R 13/447; G06V 40/16

(52) U.S. Cl. CPC G06V 20/52; G06F 3/017; H05B 47/19; G06V 40/13; G06V 40/23; H05B 47/105; H01R 13/447; G06V 40/161; G05B 2219/25011; H02G 3/081

(57) ABSTRACT

Various systems and methods for configurable modular devices are disclosed. For example, a system may be configured for swappable wiring configurations, LED light engine encodings, wireless network health determination and wireless health heatmap generation, wireless power transfer and replaceable batteries, AI modules for switch configurations, and/or the like individually and/or in combination. The system may include a modular control unit with a backplate. The backplate may include a first assembly configured to be fastened to a junction box and a removably couplable cup portion configured to be removably couplable to the first assembly and configured to electrically couple to wires of the junction box. The removably couplable cup portion may include a recess that includes a set of backplate electrical contacts.

### CROSS REFERENCE TO RELATED APPLICATIONS

The present application claims the benefit under 35 U.S.C. § 119(e) of U.S. Provisional Application Ser. No. 63/404,286, filed Sep. 7, 2022, which is incorporated herein by reference in the entirety.

The present application claims the benefit under 35 U.S.C. § 120 of U.S. patent application Ser. No. 18/209,245, filed on Jun. 13, 2023, which claims the benefit under U.S.C. § 119(e) of U.S. Provisional Application Ser. No. 63/351,729, filed Jun. 13, 2022, each of which are incorporated herein by reference in the entirety.

The present application claims the benefit under 35 U.S.C. § 120 of U.S. patent application Ser. No. 18/123,669, filed on Mar. 20, 2023 and entitled USER-UPGRADEABLE LOAD CONTROL, which claims the benefit of U.S. patent application Ser. No. 17/738,822, filed on May 6, 2022 and entitled USER-UPGRADEABLE LOAD CONTROL NETWORK, which claims the benefit of U.S. patent application Ser. No. 16/915,817, filed on Jun. 29, 2020 and entitled USER-UPGRADEABLE LOAD CONTROL NETWORK, which claims the benefit of U.S. patent application Ser. No. 16/114,047, filed on Aug. 27, 2018 and entitled OCCUPANCY SENSING APPARATUS NETWORK, which claims the benefit of U.S. Pat. No. 10,078,786 entitled OCCUPANCY SENSING APPARATUS NETWORK and issued on Sep. 18, 1018; U.S. Pat. No. 10,153,113 entitled SYSTEMS AND METHODS FOR OCCUPANCY PREDICTION and issued on Dec. 11, 2018; U.S. Patent Application number filed on Aug. 31, 2016 and entitled OCCUPANCY-BASED COMMUNICATION NETWORK; International Application No. PCT/US2016/049797, filed on Aug. 31, 2016 and entitled SYSTEM FOR CONTROLLING LIVING SPACE FEATURES; U.S. patent application Ser. No. 15/756,510, entitled SYSTEM FOR CONTROLLING LIVING SPACE FEATURES and claiming the benefit under 35 U.S.C. § 371 of International Application No. PCT/US2016/049797; U.S. Patent Number entitled MODULAR DEVICE CONTROL UNIT and issued Sep. 4, 2018; and U.S. Pat. No. 10,063,002, entitled CONFIGURABLE DEVICE CONTROL NETWORK and issued on Aug. 28, 2018; and U.S. Provisional Application No. 62/212,388, filed Aug. 31, 2015 and entitled METHOD AND APPARATUS FOR CONTROLLING LIGHTS.

International Application No. PCT/US2016/049797 claims the benefit of and is a continuation of U.S. Pat. Nos. 10,078,786, 10,153,113, 10,069,235, 10,063,002, U.S. patent application Ser. No. 15/253,819, and U.S. Provisional Application No. 62/212,388. U.S. Pat. Nos. 10,078,786, 10,153,113, and U.S. patent application Ser. No. 15/253,819 claim the benefit under 35 U.S.C. § 120 of U.S. Pat. Nos. 10,069,235 and 10,063,002. U.S. Pat. No. 10,069,235 also claims the benefit under 35 U.S.C. § 120 of U.S. Pat. No. 10,063,002. U.S. Pat. Nos. 10,153,113, 10,069,235, 10,063,002, and U.S. Patent Application number also claim the benefit under 35 U.S.C. § 119(e) of U.S. Provisional Application Ser. No. 62/212,388.

U.S. Pat. Nos. 10,078,786, 10,153,113, 10,069,235, 10,063,002, U.S. patent application Ser. Nos. 17/738,822, 16/915,817, 15/253,819, and 16/114,047, International Application No. PCT/US2016/049797, and U.S. Provisional Application No. 62/212,388 are all incorporated herein by reference in their entirety.

The present application claims the benefit under 35 U.S.C. § 120 of U.S. patent application Ser. No. 17/195,831 entitled MODULAR DEVICE BACKBONE FOR A NETWORK OF USER-SWAPPABLE PRODUCTS and filed on Mar. 9, 2021, which claims the benefit under 35 U.S.C. § 120 of U.S. patent application Ser. No. 16/915,048 entitled MODULAR DEVICE BACKBONE FOR A NETWORK OF USER-SWAPPABLE PRODUCTS and filed on Jun. 29, 2020, which claims the benefit under 35 U.S.C. § 120 of U.S. patent application Ser. No. 16/119,953 filed Aug. 31, 2018 entitled MODULAR DEVICE BACKBONE FOR A NETWORK OF USER-SWAPPABLE PRODUCTS, which claims the benefit under 35 U.S.C. § 119(e) of U.S. Provisional Application Ser. No. 62/552,601 filed Aug. 31, 2017, entitled MODULAR DEVICE BACKBONE FOR A NETWORK OF USER-SWAPPABLE PRODUCTS.

U.S. patent application Ser. Nos. 16/119,953, 16/915,048, and 17/195,831, and U.S. Provisional Application No. 62/552,601 are all incorporated herein by reference in their entirety.

### BACKGROUND

The modification of an existing electrical wiring system in a commercial or residential building is often difficult and/or costly. An electrical wiring system in a commercial or residential building typically includes a multitude of electrical circuits in which electrical wires are routed between a mains power source and electrical junction boxes placed at fixed locations throughout the building. Based on known or anticipated needs, certain electrical junction boxes are wired to have direct access to electrical power (e.g., an electrical outlet), while other electrical junction boxes are wired such that access to electrical power is controlled by electrical switches (e.g., a light or a switched electrical outlet). The electrical wiring is typically installed during a construction phase of the building, secured to support structures according to electrical and building codes, and covered during a finishing phase. In this regard, a modification of the existing wiring system in response to changing needs is generally limited to minor alterations of electrical connections within accessible electrical junction boxes or the installation of new electrical wiring, which often requires remodeling and/or refinishing.

Machine learning is a process implemented by computers to self-learn algorithms that can make predictions on data through building models from sample data inputs. There are many types of machine learning systems, such as artificial neural networks (ANNs), decision trees, support vector machines, and others. These systems first have to be trained on some of the sample inputs before making meaningful predictions with new data. For example, an ANN typically consists of multiple layers of neurons. Each neuron is connected with many others, and links can be enforcing or inhibitory in their effect on the activation state of connected neurons. Each individual neural unit may have a summation function which combines the values of all its inputs together. There may be a threshold function or limiting function on each connection and on the neuron itself, such that the signal must surpass the limit before propagating to other neurons. The weight for each respective input to a node can be trained by back propagation of the partial derivative of an error cost function, with the estimates being accumulated over the training data samples. A large, complex ANN can have millions of connections between nodes, and the weight for each connection has to be learned.

### SUMMARY

Various systems and methods for configurable modular devices are disclosed in accordance with one or more illustrative embodiments of the present disclosure. In one illustrative embodiment, a system may be configured for swappable wiring configurations, LED light engine encodings, wireless network health determination and wireless health heatmap generation, wireless power transfer and replaceable batteries, AI modules for switch configurations, and/or the like individually and/or in combination.

A system configured for swappable wiring configurations is disclosed in accordance with one or more illustrative embodiments of the present disclosure. In one illustrative embodiment, the system may include a backplate with a first assembly designed to be fastened to a junction box. In another illustrative embodiment, the system may include a removably couplable cup portion designed to be removably coupled to the first assembly and electrically coupled to wires of the junction box. In another illustrative embodiment, the backplate may be configured to be removably coupled to at least one device control assembly.

In another illustrative embodiment, the system may further include a recess that includes a set of backplate electrical contacts in the removably couplable cup portion. In another illustrative embodiment, the electrical coupling of the removably couplable cup portion to the wires of the junction box may be performed via a set of wiring electrical contacts on a wall-facing side of the removably couplable cup portion. In another illustrative embodiment, the first assembly may comprise a backplate housing, and the first assembly may be configured to be fastened to the junction box via the backplate housing. In another illustrative embodiment, the first assembly may comprise a grounding bus element comprising electrically conductive material, which may be configured to electrically ground the removably couplable cup portion. In another illustrative embodiment, the grounding bus element may comprise bus coupling features allowing for a sequential attachment of additional backplates, enabling a linear arrangement of the backplate and the additional backplates with continuous electrical coupling.

A logic system for an LED light engine (LLE) is disclosed in accordance with one or more illustrative embodiments of the present disclosure. In one illustrative embodiment, the system may include a dimmer device. In another illustrative embodiment, the system may include a logic circuit for the LLE configured to be electrically coupled to the dimmer device. In another illustrative embodiment, the logic circuit may include a decoder configured to decode waveforms received from the dimmer device based on a plurality of nonzero conduction angles of the waveforms. In another illustrative embodiment, the plurality of nonzero conduction angles may include an LLE OFF conduction angle, an LLE Min conduction angle, an LLE Max conduction angle, an OOK High conduction angle, and an OOK Low conduction angle.

A method for displaying a WiFi heatmap of a WiFi system is disclosed in accordance with one or more illustrative embodiments of the present disclosure. In one illustrative embodiment, the method may include detecting metrics of a WiFi signal at a plurality of locations in a building via a plurality of device control assemblies. In another illustrative embodiment, the method may include generating the WiFi heatmap and improvements to the WiFi system via a heatmap generation module. In another illustrative embodiment, the method may include displaying the WiFi heatmap to a user. In another illustrative embodiment, the method may include suggesting the improvements to the WiFi system. In another illustrative embodiment, the metrics taken into account by the heatmap generation module may include at least one of signal strength, bandwidth, or disconnect rate. In another illustrative embodiment, the suggesting improvements may include suggesting new access point locations, suggesting new locations for WiFi enabled nodes, suggesting new WiFi enabled nodes, or suggesting optimal locations for the WiFi enabled nodes, wherein the WiFi enabled nodes comprise at least one of WiFi access point nodes.

A system including one or more receiver devices and one or more wireless power transmitters (WPTx) is disclosed in accordance with one or more illustrative embodiments of the present disclosure. In one illustrative embodiment, the one or more receiver devices may be powered by rechargeable batteries. In another illustrative embodiment, each of the one or more WPTx may be one of a medium-field WPTX or a far-field WPTX. In another illustrative embodiment, each of the one or more receiver devices may be paired to a network. In another illustrative embodiment, each of the one or more receiver devices may communicate to one or more WPTx. In another illustrative embodiment, the one or more WPTx may be located in one or more modular control units of a mesh network.

An artificial intelligence method is disclosed in accordance with one or more illustrative embodiments of the present disclosure. In one illustrative embodiment, the method may include storing historical profile data and an artificial intelligence (AI) module in a memory. In another illustrative embodiment, the method may include detecting smart device installations. In another illustrative embodiment, the method may include suggesting improvements to a smart-home set up based on the smart device installations. In another illustrative embodiment, the AI module may be configured to generate the suggested improvements based on at least one of in-profile usage, seasonal shifts, occupancy data, or device type. In another illustrative embodiment, the suggested improvements may include at least one of device names, device zones, device scenes, schedules, or timers.

A system including a controller communicatively coupled to the system is disclosed in accordance with one or more illustrative embodiments of the present disclosure. In one illustrative embodiment, the controller may include one or more processors configured to execute program instructions. In another illustrative embodiment, the one or more processors may be caused to receive a machine learning module. In another illustrative embodiment, the one or more processors may be caused to receive node data of one or more nodes. In another illustrative embodiment, the one or more processors may be caused to generate output data indicative of a configuration of one of the one or more nodes, a user suggestion for one of the one or more nodes, or a category for one of the one or more nodes. In another illustrative embodiment, the machine learning module may be generated based on training data configured to correlate training inputs to training outputs of the training data. In another illustrative embodiment, the training inputs may include at least one of node names, node locations, node categories, occupancy data, node device types, in-profile usage of a node, seasonal shifts, or node zone locations. In another illustrative embodiment, the training outputs may include at least one of schedules, timers, categories, or node network layout configurations.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1A is an exploded view of a modular control unit configured to mount within an electrical junction box, in accordance with one or more embodiments of the present disclosure.

FIG. 1B is an exploded view of two backplates mounted to a 2-gang electrical junction box, in accordance with one or more embodiments of the present disclosure.

FIG. 2A is a simplified side view of a backplate with a removably couplable cup portion, in accordance with one or more embodiments of the present disclosure.

FIG. 2B is a simplified back view of the backplate with the removably couplable cup portion, in accordance with one or more embodiments of the present disclosure.

FIG. 2C is a simplified front view of the backplate with the removably couplable cup portion, in accordance with one or more embodiments of the present disclosure.

FIG. 2D is a simplified front view of the backplate installed in a junction box with fasteners, in accordance with one or more embodiments of the present disclosure.

FIG. 3A is a front view of a grounding bus element of the backplate, in accordance with one or more embodiments of the present disclosure.

FIG. 3B is a front view of a different grounding bus element of the backplate, in accordance with one or more embodiments of the present disclosure.

FIG. 4 is a front view of a removably couplable cup portion, in accordance with one or more embodiments of the present disclosure.

FIG. 5A is a view of a linear arrangement of four interconnected backplates installed in a four-gang junction box, in accordance with one or more embodiments of the present disclosure.

FIG. 5B is a front view of a linear arrangement of four interconnected backplates, in accordance with one or more embodiments of the present disclosure.

FIG. 6A is an isometric view of a backside of a backplate, in accordance with one or more embodiments of the present disclosure.

FIG. 6B is an isometric view of a backside of a removably couplable cup portion showing wiring electrical contacts, in accordance with one or more embodiments of the present disclosure.

FIG. 7 is a block diagram of a logic circuit in a HELD configuration, in accordance with one or more embodiments of the present disclosure.

FIG. 8 is a schematic of a LED light engine circuit that includes the logic circuit of FIG. 7, in accordance with one or more embodiments of the present disclosure.

FIG. 9A is a half duty cycle of a waveform with a single conduction angle corresponding to a time on period, in accordance with one or more embodiments of the present disclosure.

FIG. 9B is a two full duty cycles of a waveform with each half duty cycle including a conduction angle corresponding to a time on period, in accordance with one or more embodiments of the present disclosure.

FIG. 10 is a conceptual block diagram of a heatmap generation module, in accordance with one or more embodiments of the present disclosure.

FIG. 11 is a heatmap generated by the heatmap generation module.

FIG. 12 is a conceptual diagram of a wireless power transmitter (WPTx).

FIG. 13 is a conceptual block diagram of an artificial intelligence (AI) module, in accordance with one or more embodiments of the present disclosure.

FIG. 14 is a floorplan view of a system including sensors configured for automation, in accordance with one or more embodiments of the present disclosure.

FIG. 15 is a conceptual view of a person falling to the ground, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

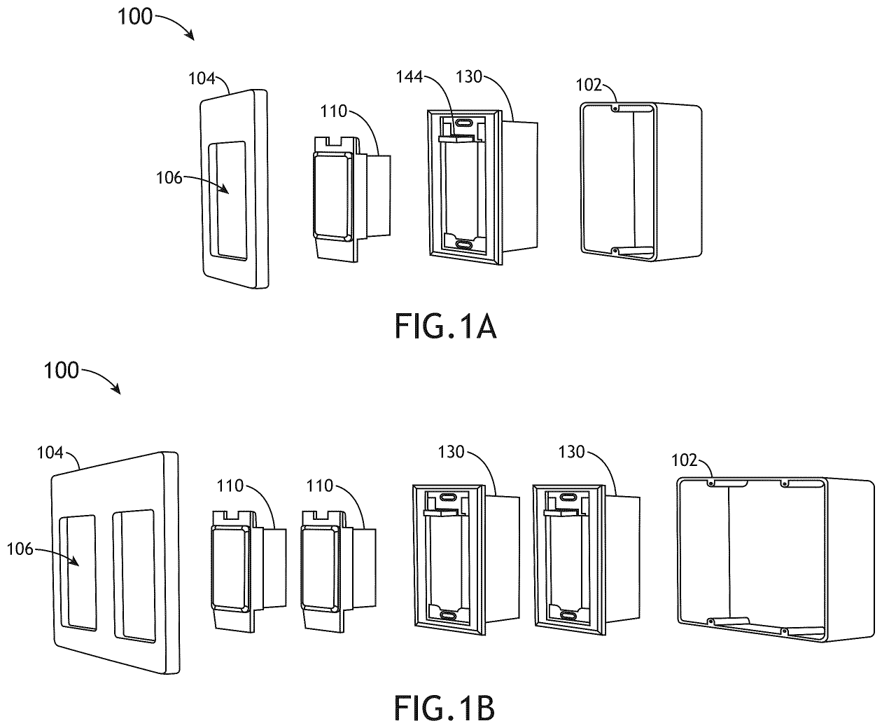

Referring generally to FIGS. 1A through 6B, a configurable network of device controllers is described, in accordance with one or more embodiments of the present disclosure. Embodiments of the present disclosure are directed to backplates with removably couplable cup portions for interchangeability of one-way, three-way, or four-way switch configurations. Further embodiments are directed to a network of backplates electrically connected to mains power to facilitate a network of modular device controllers.

Note that backplates 130 configured to be removably couplable to device control assemblies 110 are generally disclosed in U.S. Pat. No. 10,063,002, filed Mar. 18, 2016, which is herein incorporated by reference in its entirety. Nonlimiting examples of faceplate 104 and junction box 102 are also disclosed and may be used in one or more embodiments.

Backplate designs present many challenges. Many backplates may differ only slightly in their design. This difference typically revolves around whether the backplate is designed to be used with, for example, a standard 1-way, 3-way, or 4-way type (e.g., backplate configured for 3-way lighting wiring switch setup). For example, a backplate may be configured for only 3-way switches via the number of wiring terminals/contacts. In addition, there may be shipping and logistical inefficiencies with other backplate designs. For example, needing multiple backplate types, at least one for each different wiring type (e.g., 3-way type), potentially requires complicated inventory management and costs such as keeping vendors supplied in all possible backplate types.

Another challenge is that backplates are not necessarily the easiest to install or replace. For example, changing a backplate from a 1-way to a 4-way backplate may be a relatively slow process compared to doing so using one or more embodiments of the present disclosure.

Therefore, it is desired to have a backplate that overcomes at least some of these challenges. In this regard, at least some embodiments of the present disclosure possess benefits such as, but not limited to, being highly manufacturable; low cost; compatible with 1-way, 3-way, 4-way circuits, and the like; improved serviceability/replaceability; and/or reducing logistical/inventory inefficiencies of shipping entire backplates that are only compatible with one type of switch setup (e.g., only 3-way switch backplates).

Differences between backplates for different circuit setups may be confined to a small location of the backplate. For example, portions of the backplate such as a “cup” portion or the like may include the entirety of or most of the differences (e.g., number of terminals) between different backplate types.

Accordingly, the present disclosure is directed to backplates with a removably couplable cup portion. More specifically, the present disclosure is directed to a backplate that improves serviceability/replaceability and manufacturability using a removably couplable cup portion to, for example, allow modular swapping of different cup portions to provide for compatibility for a variety of wiring types.

Removably couplable may mean nondestructively couplable and re-couplable, structurally and/or electrically.

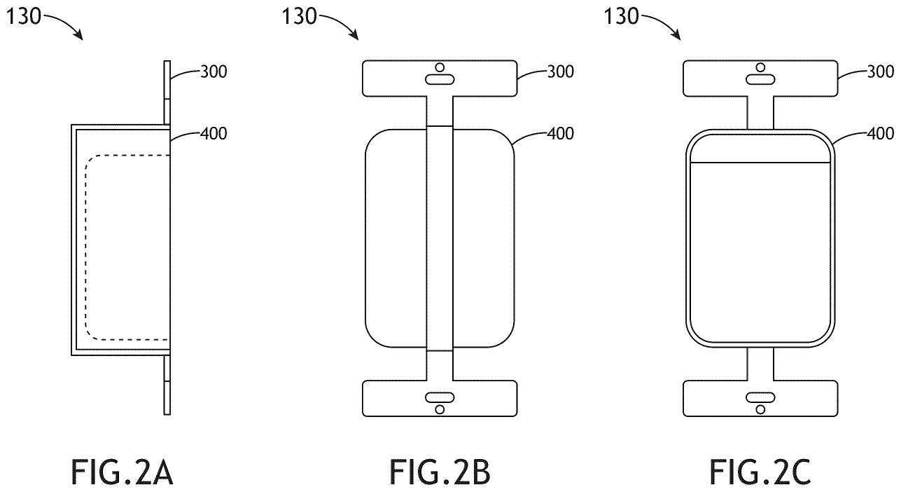

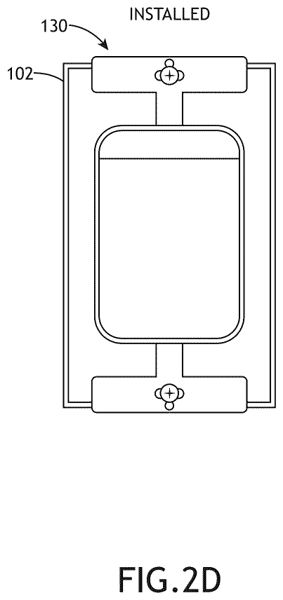

FIG. 1A is an exploded view of a modular control unit 100 configured to mount within an electrical junction box 102, in accordance with one or more embodiments of the present disclosure. FIG. 1A and FIG. 1B may be used to introduce concepts such as coupled assemblies of backplates 130, junction boxes 102, device control assemblies 110, and the like, but does not necessarily limit the present disclosure. For example, the backplate 130 may include a removably couplable cup portion such as cup portion 400 in FIG. 2A.

In some embodiments, the modular control unit 100 includes a backplate 130 configured to mount within an electrical junction box 102 and provide an electrical connection to an electrical wiring system. In some embodiments, a modular control unit 100 includes a device control assembly 110 to control one or more load devices and is configured to removably couple with the backplate 130. Further, the modular control unit 100 may include a faceplate 104 configured to cover the electrical junction box 102. In this regard, a backplate 130 may provide a standardized mounting assembly for device control assemblies 110. Further, device assemblies 110 may be removably and/or interchangeably connected to the electrical wiring system through the backplate 130. The backplate 130 may be an intermediary part wired to the electrical wiring system to provide safe, hot-swappable electrical contacts to modularly swappable device control assemblies 110.

For the purposes of the present disclosure, a load device may include any device directly or indirectly attached to the electrical wiring system. For example, a load device may include a wired load such as, but not limited to, a luminaire or a fan. As an additional example, a load device may include an electrical outlet into which loads may be removably connected.

In alternating current (AC) outlets, it is sometimes desirable to have recessed receptacles (not shown) to allow for furniture to be placed flush against the wall.

In some embodiments, a receptacle (e.g., outlet) is constructed (configured) so that it can plug into a backplate 130. For example, the location of the receptacle (e.g., user accessible plugs) may be located in a location that is the same location as that of a user interface 112 to the backplate 130. For example, such a location of a user interface 112 may be configured to be “flush” or nearly flush with a wall. In this way, the receptacle (e.g., outlet) depth can take advantage of the depth of the backplate 130 recess.

In some embodiments, a device control assembly 110 includes electrical circuitry and/or mechanical components to actuate, regulate, or otherwise control one or more load devices connected to the electrical wiring system. For example, a device control assembly 110 may include, but is not limited to, one or more power control elements configured to control the power (e.g., one or more input devices, one or more buttons, mechanical switches, one or more electrical relays, one or more MOSFETs (metal-oxide-semiconductor field-effect transistors) or one or more TRIACs (triode for alternating current)). It should be noted that a TRIAC is a “switch”. In this regard, a device control assembly 110 may include, but is not limited to, a toggle switch, a dimmer switch, an alternating current (AC) electrical outlet, a direct current (DC) electrical outlet (e.g., a universal serial bus (USB) outlet), or a multi-function keypad. Additionally, a device controller assembly 110 may include, but is not limited to, one or more display devices, one or more speakers, one or more microphones, or one or more sensors.

In some embodiments, the backplate 130 is configured to electrically connect to an electrical wiring system through the electrical junction box 102. For example, the backplate 130 may connect to a power distribution panel through an electrical wiring system terminated at the electrical junction box 102. Additionally, the backplate 130 may be configured to terminate a power cable with any number of conductors such as, but not limited to, a two-conductor power cable, a three-conductor power cable, or a four-conductor power cable. It is noted herein that the backplate 130 may be compatible with any electrical wiring system in any configuration. For example, the backplate 130 may, but is not limited to, be configured to accept a wire connected to a ground source (e.g., a “ground” wire), a wire connected to a power source (e.g., a “hot” wire), a wire connected to a neutral bar (e.g., a “neutral” wire), or one or more additional wires (e.g., one or more “traveler” wires). Further, the backplate 130 may be configured to accept any gauge of wire. In some embodiments, the backplate 130 accepts 14-gauge wire (e.g., from a 14/2 power cable or a 14/3 power cable). In some embodiments, the backplate 130 accepts 12-gauge wire (e.g., from a 12/2 power cable or a 12/3 power cable). It is recognized herein that electrical systems may include any number of switches or connections between components. As such, the description of electrical wiring systems above is presented solely for illustrative purposes and should not be interpreted as limiting. As noted below, a removably couplable cup portion 400 configured for a specific wiring setup (e.g., a 1-way switch, a 3-way switch, or a 4-way switch) may be used to allow for swapping out less than the entire backplate 130 for different wiring configurations. This may reduce cost by not needing to ship and store in inventory entire, non-modular backplates 130 configured for each wiring configurations.

A backplate 130 may be electrically connected to an electrical wiring system through the electrical junction box 102. In some embodiments, a backplate 130 is configured to connect to an electrical wiring system through twist-on wire connectors. For example, a backplate 130 may include one or more wires suitable for connecting to a power cable through twist-on wire connectors. In some embodiments, the backplate 130 is configured to connect to an electrical wiring system through pressure-plate wire connectors (which may be therefore included in the backplate 130). In some embodiments, the backplate 130 is configured to connect to an electrical wiring system through screw terminal wire connectors. In some embodiments, the backplate 130 is configured to connect to an electrical wiring system through push-in wire connectors. For example, a backplate 130 may include one or more push-in connectors to connect to conductors in a power cable such as, but not limited to, a “hot” wire, a “neutral” wire, a “ground” wire, or a “traveler” wire.

In some embodiments, a backplate 130 is configured to interchangeably couple to device control assemblies 110 without modification of the connection between the backplate 130 and the electrical wiring network. For example, a device control assembly 110 configured to operate as a toggle switch may be removed and replaced with a device control assembly configured to operate as a dimmer switch without modification to the backplate 130 or the associated electrical connections to the electrical wiring network. In this regard, the modular control unit 100 provides a semi-permanent element (e.g., a backplate 130 attached to an electrical junction box 102 via one or more screws) connected to the electrical wiring system and interchangeable functional units (e.g., a device control assembly 110).

In some embodiments, a device control assembly 110 may be inserted into or removed from a backplate 130 while a backplate 130 is connected to live power from the electrical wiring assembly. For example, an electrical connection established between a backplate 130 and a device control assembly 110 may be configured to establish a ground connection prior to establishing a “hot” wire connection.

A backplate 130 may be configured to occupy one or more device positions within an electrical junction box 102. In some embodiments, a backplate 130 is configured to occupy one position within an electrical junction box 102. In this manner, a single backplate 130 may be mounted to a 1-gang electrical junction box 102, two backplates 130 may be mounted to a 2-gang electrical junction box 102, or the like. FIG. 1B is an exploded view of two backplates 130 mounted to an electrical junction box 102, in accordance with one or more embodiments of the present disclosure. For example, two backplates 130 mounted in a 2-gang electrical junction box 102 may accept two device control assemblies 110 and a 2-opening faceplate 104. Further, a backplate 130 may be mounted to an electrical junction box 102 alongside one or more additional devices. For example, a backplate 130 and a typical light switch may be mounted within 2-gang electrical junction box 102. In some embodiments, a backplate 130 is configured to occupy two or more positions within an electrical junction box 102. For example, a single backplate 130 may be configured to accept two or more device control assemblies 110 such that each device control assembly 110 effectively occupies a single position within the electrical junction box 102. As an additional example, a backplate 130 occupying two or more positions within an electrical junction box 102 may accept one or more device control assemblies 110 of any size. In this regard, a single device control assembly 110 may effectively occupy any portion of an electrical junction box 102.

In some embodiments, the modular control unit 100 includes a faceplate 104 to cover a portion of the electrical junction box 102 not covered by the backplate 130 or the device control assembly 110. In some embodiments, the faceplate 104 includes one or more openings 106 to provide access to one or more elements of the device control assembly 102. For example, the faceplate 104 may include, but is not limited to, one or more openings 106 to provide access to one or more displays, one or more speakers, one or more microphones, one or more antennas, or one or more sensors associated with a device control assembly 110. In some embodiments, the faceplate 104 provides access to one or more elements of the device control assembly 110 while covering exposed areas of the electrical junction box 102. For example, a device control assembly 110 and/or a backplate 130 attached to an electrical junction box 102 may leave one or more areas of the electrical junction box 102 exposed. In this regard, a faceplate 104 may cover the one or more exposed areas of the electrical junction box 102.

FIGS. 2A through 2D illustrate simplified views of a backplate 130 with a removably couplable cup portion 400, in accordance with one or more embodiments of the present disclosure. FIG. 2A illustrates a simplified side view, FIG. 2B illustrates a simplified back view, FIG. 2C illustrates a simplified front view, and FIG. 2D illustrates a simplified front view installed in a junction box 102.

In some embodiments, as shown in FIG. 2D, the backplate 130 is configured to be fastened (e.g., via screw holes and screws) to a junction box 102. For example, elements of the backplate 130 which are not the cup portion 400 may be referred to as a first assembly (e.g., backplate housing, grounding bus element), and be configured to be fastened to the junction box 102 so that the cup portion 400 may be swapped out, and the first assembly may stay securely fastened to the junction box 102.

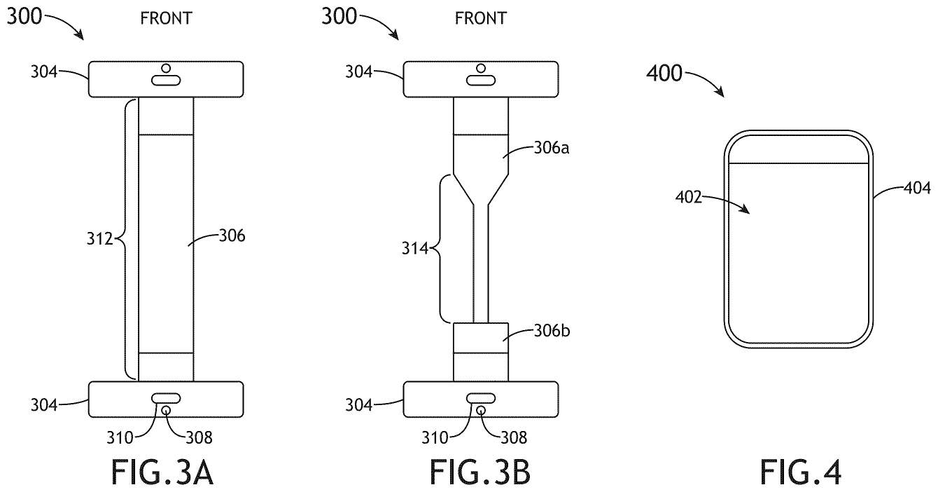

FIG. 3A illustrates a front view of a grounding bus element 300 of the backplate 130, in accordance with one or more embodiments of the present disclosure.

The grounding bus element 300 may include electrically conductive material (e.g., metal such as copper, steel). The electrically conductive material may be configured to electrically ground one or more other elements (e.g., device control assemblies 110, switches, load devices, cup portion 400, and/or the like) to the electrical wiring system of a building and the like.

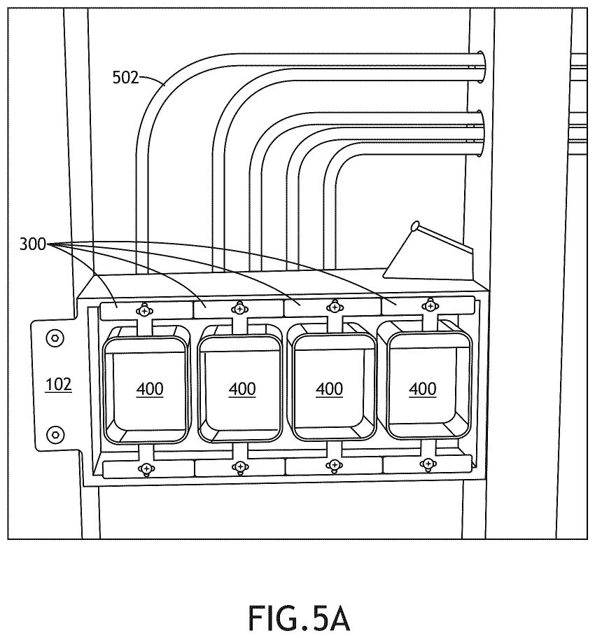

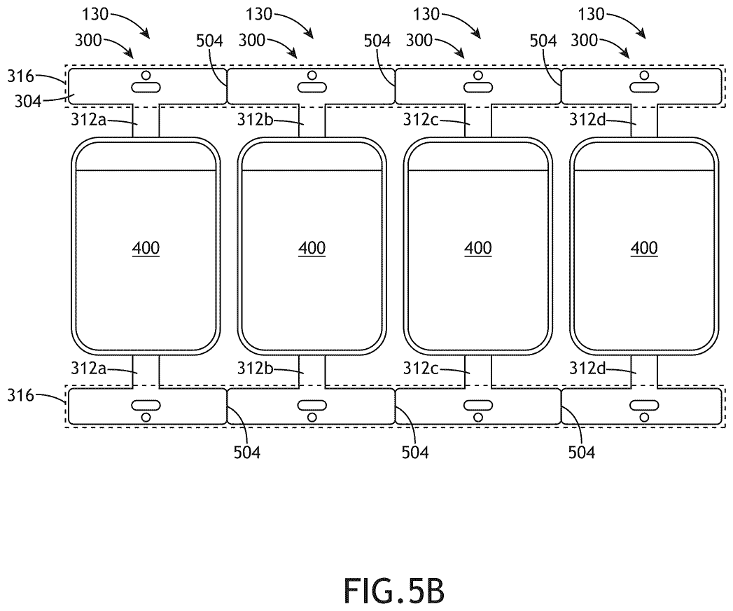

The grounding bus element 300 may include a first horizontal bus bar 304 at an upper end (e.g., when viewed from the front in a position to be installed in a standard junction box orientation (vertical)) and a second horizontal bus bar 304 at a lower end of the grounding bus element 300. For instance, the grounding bus element 300 may include a connecting portion 312 coupled to the first horizontal bus bar 304 and the second horizontal bus bar 304. In this way, the connecting portion 312, the first horizontal bus bar 304, and the second horizontal bus bar 304 may, in a sense, form a capital “I” shape, with four corners. Each side (e.g., left side and right side) of each horizontal bus bar 304 may include a lateral distal side end. For example, as shown, a total of four corners of a capital “I” shape may approximate the location of the lateral distal side ends. In embodiments, as shown in FIG. 5B, each lateral distal side end may include a bus coupling feature 504 to allow for a lateral sequential attachment of the additional backplates 130.

The connecting portion 312 may include (and/or be) a metal yoke. The connecting portion 312 may be made of any conductive metal (e.g., copper, steel) that, for example, satisfies the appropriate building standards. The connecting portion 312 may be formed in such a way that a plastic housing 600 for electrical components of a cup portion 400 fits securely inside.

The first assembly (e.g., grounding bus element 300 and/or backplate housing 600) may include system fastening features 310 (e.g., screw holes defined by a surface of the first assembly) configured to be fastened to a junction box 102. For example, two screw holes 310, one each in an upper and lower bus bar 304 and two screws may be used.

The first assembly (e.g., grounding bus element 300 and/or backplate housing 600) may include faceplate fastening features 308 (e.g., screw holes) configured for coupling a faceplate 104 to the backplate 130. For example, a faceplate fastening feature 308 may be included above an upper system fastening feature 310 and below a lower system fastening feature 310 as shown.

The grounding bus element 300 may include a recessed portion 306 configured to receive the removably couplable cup portion 400. For example, the connecting portion 312 may include the recessed portion 306. The recessed portion 306 may be in a C-shape or the like when viewed from a side view.

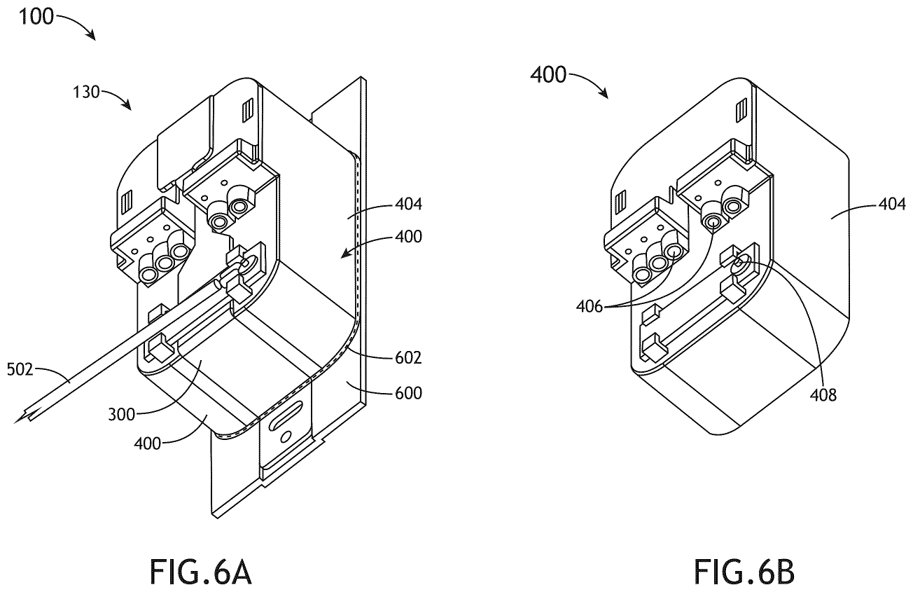

As shown in FIG. 3B, the recessed portion 306 may include a tapered portion 314, such as may allow more space for a compact arrangement of wiring electrical contacts 406 (shown in FIG. 6B), and which may include contact 408.

FIG. 4 is a front view of a removably couplable cup portion 400, in accordance with one or more embodiments of the present disclosure. FIG. 4 illustrates a removably couplable cup portion 400 that is not coupled to a first assembly.

The removably couplable cup portion 400 may include a cup housing 404 (e.g., shell). For example, the cup housing 404 may include plastic material.

The removably couplable cup portion 400 may include and/or define a recess 402 (e.g., for receiving a device control assembly 110). The recess 402 may include a set of backplate electrical contacts (not shown in simplified view) (e.g., for electrically coupling to the device control assembly 110). The backplate 130 may be configured to be removably coupled to at least one device control assembly 110, the at least one device control assembly 110 including a set of device control assembly electrical contacts configured to electrically couple with the set of backplate electrical contacts when the at least one device control assembly 110 is coupled to the backplate 130 and configured to electrically decouple from the set of backplate electrical contacts when the at least one device control assembly 110 is decoupled from the backplate 130. This may enable modular swapping of device control assemblies 110 such as a non-dimmable light switch for a dimmable light switch.

The cup housing 404 may be in the shape of a cup. For example, the housing 404 may enclose a volume, but for one or more open sides (e.g., one open front, one open front and two opposing open sides, and/or the like).

In some embodiments, the backplate 130 may only be compatible with itself, such that the backplate 130 is not able to be daisy-chained (i.e., interconnected with multiple backplates) and is only configured for only a single-gang junction box (e.g., such as backplate 130 of FIG. 6A). However, the system 100 may have various features (e.g., keying features 504) that allow the backplates 130 to interlink and form groups with similar dimensions to allow for multi-gang backplate assemblies (e.g., two gang and three gang). This may allow the system to be used in a larger junction box and with a multi-gang face plate, such as shown in FIGS. 5A and 5B.

FIG. 5A is a view of a linear arrangement of four interconnected (e.g., electrically grounded and structurally coupled together) backplates 130 installed in a four-gang junction box 102, in accordance with one or more embodiments of the present disclosure. As shown, the removably couplable cup portions 400 may be coupled to wires 502 (e.g., ground wires, hot wires, communication wires, and/or the like) of the junction box 102.

FIG. 5B is a front view of the linear arrangement of four interconnected backplates 130, in accordance with one or more embodiments of the present disclosure.

As noted, the grounding bus element 304 of each backplate 130 may include bus coupling features 504 (e.g., located at four lateral distal side ends). The include bus coupling features 504 may allow for a sequential attachment of additional backplates 130 (e.g., a 2^{nd}, 3^{rd}, and 4^{th} backplate 130 on either side, continuously), enabling a linear arrangement of the backplate 130 and the additional backplates 130 with continuous electrical coupling.

In this regard, each bus bar 304 may connect to one or two other bus bars 304 in a sequence to define a bus bar assembly 316. For example, for two or more coupled backplates 130 with two bus bars 304 each, two bus bar assemblies 316 may be formed for continuous electrical grounding of all backplates 130. The bus bar assemblies 316 may be electrically coupled via respective connecting portions 312a, 312b, 312c, 312d of each backplate 130.

FIG. 6A illustrates an isometric view of a system 100 including a backside of a backplate 130, in accordance with one or more embodiments of the present disclosure.

The removably couplable cup portion 400 may include one or more (e.g., 1, 2, 3, 4, 5, 6, 7, 8, and/or the like) of wiring electrical contacts 406, 408 (e.g., wiring terminals/connectors). The wiring electrical contacts 406, 408 of the removably couplable cup portion may be configured for one of: a 1-way switch, a 3-way switch, or a 4-way switch. For example, a first wiring electrical contact 408 may be configured to be a connected to a ground wire and the grounding bus element 300 to enable electrical grounding. One or more second wiring electrical contacts 406 may be configured to be a connected to other wires (e.g., hot wires, relay wires, and/or the like). For example, a particular removably couplable cup portion 400 may be configured for only a 3-way switch (e.g., configured by the number and arrangement of wiring electrical contacts 406, 408). In this regard, in some examples, the electrical coupling of the removably couplable cup portion 400 to the wires 502 of the junction box 102 is configured to be performed via wiring electrical contacts 406, 408. The wiring electrical contacts 406, 408 may be located on a wall-facing side (e.g., backside) of the removably couplable cup portion 400.

The removably couplable cup portion 400 may be removably coupled (and/or configured to be removably couplable) to a first assembly (e.g., backplate housing 600) at an interface 602 as shown. For example, the interface 603 at the backplate housing 600 and/or removably couplable cup portion 400 may include removably couplable features such as, but not limited to, tabs, corresponding tab voids, snaps, slots, hooks, protrusions configured to be inserted into slots, and/or the like.

FIG. 6B illustrates an isometric view of a wall-facing side (e.g., backside) of a removably couplable cup portion 400 which is not coupled to a first assembly, in accordance with one or more embodiments of the present disclosure.

In embodiments of the system, the removably couplable cup portion 400 may couple to the backplate via one or more alignment and/or one or more coupling surfaces of the interface 602. For example, the interface 602 may include snap surfaces (e.g., flexible tabs with a ridge). The snap surfaces of one component may couple to complementary snap surfaces (e.g., slots, voids, recesses, and the like configured to receive the snap surfaces) of the other component (e.g., first assembly, cup portion 400). This may make the cup portion 400 easier to install and replace (i.e., swap out).

Further, this design may allow for the manufacture of separate removably couplable cup portions 400 for each wiring type. For example, the removably couplable cup portion may be manufactured to be compatible with 1-way, 3-way, and/or 4-way switches. This may lower shipping and production costs by having a large, standard part and smaller, alternate attachments to the standard part. In embodiments, it may be easier for users to determine what type of circuit they are interacting with by removing the removably couplable cup portion 400 from the first assembly and inspecting the connectors 406 of the removably couplable cup portion 400. In embodiments, different colored tabs may be used to denote the circuit type that the removably couplable cup portion 400 are designed to be used with.

The bus coupling features 504 of the ground bus-bars 304 may also help align the backplates 130 when installing them into a junction box 102, particularly when the backplates 130 are not linked together. The backplate 130 may have a double line and double neutral for bridging connections.

The backplate 130 may also have features to help align a faceplate 104. For example, the backplate 130 may have features (e.g., ridges, chamfers, or bevels) to align the faceplate 104 in the X, Y, and Z direction. In addition, these features may also correct skew and pitch of the faceplate 104.

The removably couplable cup portion 400 may, in a sense, make it easier to switch the location of certain backplates 130. For example, instead of unwiring and taking out an entire backplate assembly, only to rewire the new backplate assembly, the wiring may stay connected to the removably couplable cup portion 400 while allowing the first assembly (e.g., outer backplate housing 600) to be removed and replaced. In this way, the system 100 (e.g., backplate housing 600) may also be easily compatible with standard size products or products that are larger than standard size products. For example, a standard size backplate housing 600 may be decoupled from the removably couplable cup portion 400 and a different size backplate housing 600 may then be coupled to the removably couplable cup portion 400.

Backplates 130 may include an air gap actuator 144 as shown in FIG. 1A. For instance, U.S. patent application Ser. No. 15/074,915, filed Mar. 18, 2016, which is hereby incorporated by reference in its entirety discloses an airgap actuator 144. Backplates 130 with air gap actuators 144 may be disclosed in U.S. Pat. No. 10,699,131, filed Aug. 27, 2018, which is herein incorporated by reference in its entirety.

The airgap actuator 144 may provide protection for electrical contacts (e.g., backplate electrical contacts) of the backplate 130 and only expose them under certain conditions (e.g., when a faceplate 104 is inserted). In embodiments, the backplate 130 may include a push to release feature 144 as shown in FIG. 1A that allows the air gap actuator to be disengaged upon application of a force to the backplate 130, therefore exposing the electrical contacts.

Further, in some embodiments, the wires 502 and junctions (e.g., wiring electrical contacts 406) are built into the junction box 102 (e.g., the removably couplable cup portion 400 is a nonremovable, permanent, and/or semi-permanent part of the junction box wiring). It is contemplated that a removable coupling of the first assembly to the removably couplable cup portion 400 may allow all wires 502 and junctions to be built into the junction box. This may prevent wires 502 from becoming loose or disconnected from a standard backplate assembly or from the removably couplable cup portion 400.

Embodiments of a logic system including dimmers and/or LED Light Engine (LLE) devices are disclosed herein.

Dimmer switches are traditionally thyristors (e.g., triodes for alternating current (TRIAC)). TRIAC based dimmers are used primarily as light switches and may comprise a large majority of dimmer switches in use. Further, traditional TRIAC dimmers may not function as desired with every light fixture. For example, there may be non-linearity with dimming features (e.g., lights become brighter or dimmer than a corresponding linear movement distance of a dimmer sliding mechanism would indicate). Dimmers may also cause unwanted flickering in light fixtures (e.g., LLEs) when dimming or brightening lights. There exists a desire for a dimmer that addresses one or more of these challenges.

A logic system for a light emitting diode (LED) light engine is disclosed according to one or more embodiments of the present disclosure.

In embodiments, an LED light engine (LLE) system (e.g., logic system) may consist of, but is not limited to, an alternating current (AC)/direct current (DC) rectifier, various logic, a constant-current driver circuit, and/or one or more LEDs. The logic associated with an LLE may be any logic module suitable for dimming operations with an LLE. Further, a light engine may include (or be) any integrated LED light fixture unit capable of performing logic operations. Improved logic functions may be desirable to improve the linearity and flicker performance of the LLE. The improved logic may also allow additional features and/or commands to be added to the LLE. When the improved logic is combined with an LLE, an LLE flicker-free or flicker-reduced system may be provided for with linear adjustability. The improved logic may be integrated into the driver integrated circuit (IC), and therefore change the behavior of the driver IC.

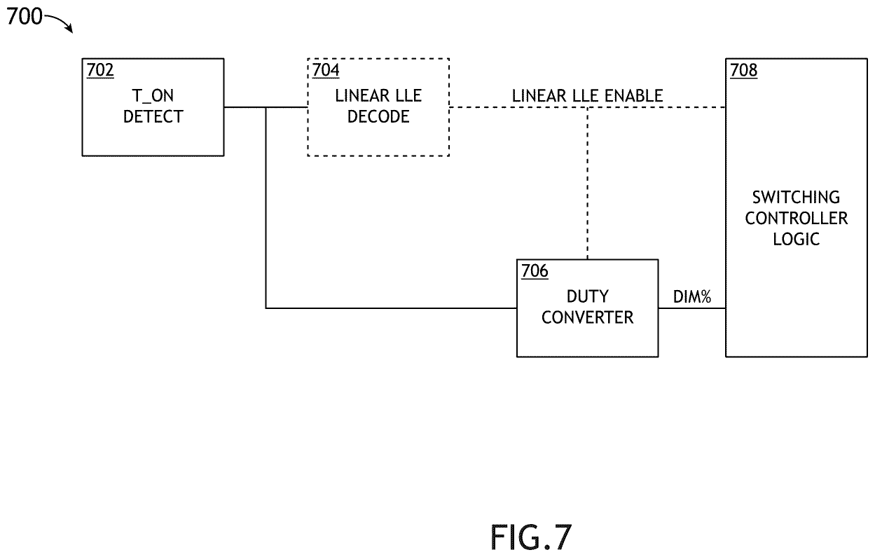

FIG. 7 illustrates a block diagram of a logic circuit 700 of a logic system in a HELD configuration for use in a driver circuit of an LLE, in accordance with one or more embodiments of the present disclosure.

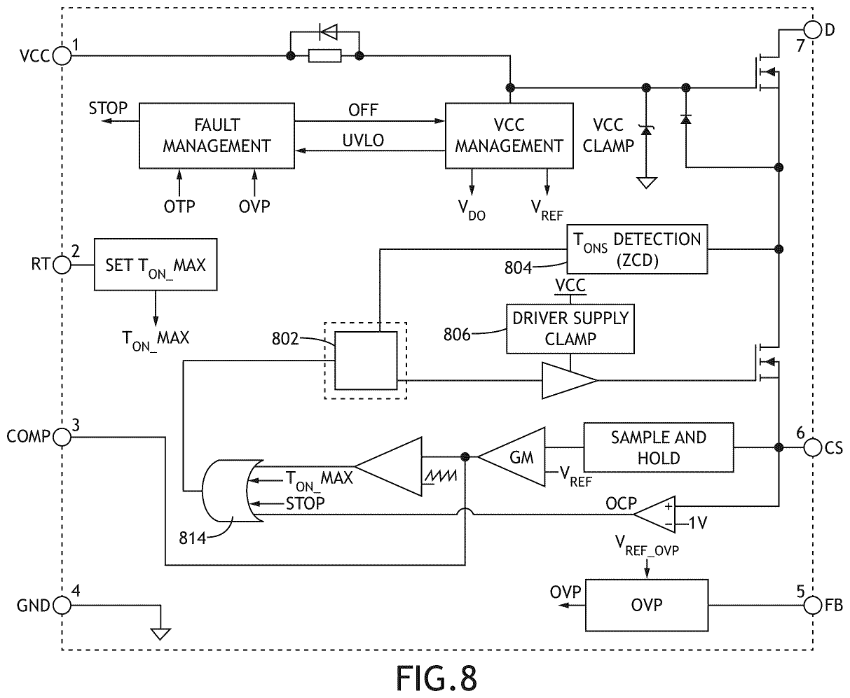

FIG. 8 illustrates a schematic of an LLE driver circuit of a logic system 800 that includes the logic circuit 700, 802 of FIG. 7, in accordance with one or more embodiments of the present disclosure. The system 800 may be and/or include a circuit board (e.g., printed circuit board (PCB)) with elements such as the elements in FIG. 7 and/or FIG. 8. For example, the logic circuit 700 of FIG. 7 may be located at location 802 of FIG. 8, thereby adding a decoder to the LED light engine circuit.

In some embodiments, the system 800 (e.g., logic system 800) may be configured to interpret alternating current waveforms of a switch (e.g., TRIAC switch) to determine whether a compatible dimmer device is attached (e.g., electrically coupled). For example, aspects (e.g., phase, frequency, shape, intensity) of a waveform received from a potentially compatible dimmable device may inherently be indicative of what type of device the potentially compatible dimmable device is. Values of such aspects of the waveform may be determined (e.g., via physically measuring waveforms coming from such devices when installed and storing such values in memory, etc.). For instance, program instructions stored in memory 1006 of a controller 1002 of an LLE may be configured to determine whether values of a measured waveform of a coupled dimmer device is compatible with the system 800, such as if the value(s) fall inside and/or outside a threshold range and/or threshold value. In some examples, the dimmer device may be configured to encode information in the waveform. For example, the encoded information may be based on identifying codes indicative of which types of dimming logic the dimmer device is compatible with, or other bits of data extractable from the waveform. Further, such encoded information may be configured to be received/analyzed/interpreted/decoded by the system 800 to extract such encoded information. For example, such configurations may be referred to as a “communication protocol.”

If the LLE logic system 800 determines that there is not a compatible dimmer device attached, the system 800 may (still) be configured to operate in some (but not necessarily all) capacities. For example, in such an instance, the system 800 may be configured to provide power to the noncompatible device but may be reduced in ability to utilize the various benefits of this portion of the disclosure such as flicker reduction and encoded information.

Implementation of the HELD circuit 700 as an alteration to existing circuit designs may allow a dimmer to be used with many different light sources without a need for large overhauls of existing systems.

The detection of a compatible dimmer may be configured to be initiated at first power-on of the dimmer. For example, a compatible dimmer may be configured to send an encoded message to the LLE system 800 listing the features the dimmer supports and the LLE system 800 may be configured to receive such information, and/or vice versa. In some embodiments, messages may be configured to be sent between the dimmer and the LLE system 800 over branch circuit wiring using on/off keying (OOK) to send/encode a message. OOK may be used on each half-cycle with a sufficient pre-amble to ensure the LLE is powered on.

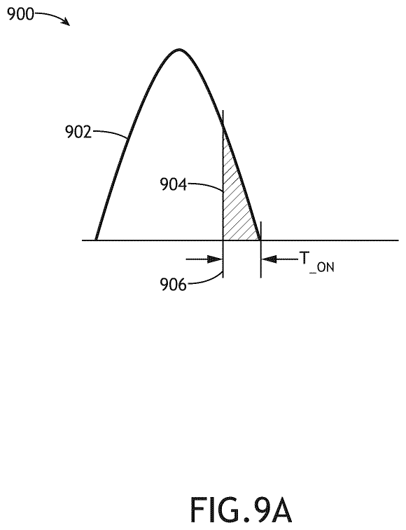

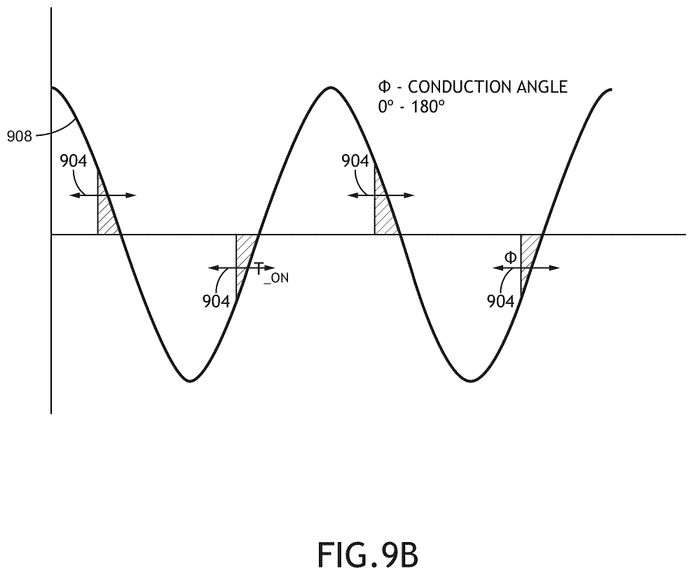

FIG. 9A illustrates a half duty cycle 902 of a waveform 900 with a single conduction angle 904 corresponding to a time on period 906, in accordance with one or more embodiments of the present disclosure.

FIG. 9B illustrates a two full duty cycles 908 of a waveform 910 with each half duty cycle including a conduction angle 904 corresponding to a time on period 906, in accordance with one or more embodiments of the present disclosure.

In some embodiments, these cycles 902, 908 may correspond to encoded messages sent between the dimmer and the LLE system 800.

In some embodiments, the conduction angle 904 may correspond to different functions of the LLE system 800. For example: a conduction angle 904 of 18° may correspond to the LLE system 800 being off (e.g., not providing power to an LED; LLE OFF), a conduction angle of 24° may correspond to the LLE system 800 being on (e.g., providing power) at a minimum brightness (e.g., minimum conduction angle 904; LLE Min), a conduction angle of 144° may correspond to the LLE system 800 being on at a maximum brightness (e.g., maximum conduction angle 904; LLE Max), a conduction angle of 36° may correspond to OOK being relatively high (e.g., higher than a middle value; OOK HIGH), and a conduction angle of 24° may correspond the OOK being relatively low (e.g., lower than a middle value; OOK LOW).

In an embodiment, the system 800 may be configured such that at LLE OFF, when the conduction angle 904 is small enough that no power reaches and illuminates the LED, the LLE system 800 still has enough power to listen for an encoded message from the dimmer device.

When the dimmer device is on and in a compatibility mode, it may be configured to accept/receive any number of commands. For example, possible commands may include, but are not limited to: LLE on, LLE off, dim level, LLE color temperature control (e.g., allows users to change between warm and bright light), LLE color control (e.g., allows users to change the color of LEDs), and/or fade time (e.g., how long it takes the lights to fade from on to off).

In one embodiment, a command may be sent to the LLE system 800 using a fully digital method of communication. In this manner, all commands may be sent using OOK. This may allow for changing the LLE color temperature, LLE color, fade time, or dim level with commands sent directly from the dimmer switch device. However, the logic on all compatible LLE systems 800 may require the OOK circuits to be active. Therefore, dimmer devices may require a method of getting out of compatibility mode.

In another embodiment, a command may be configured by the dimmer device to be sent to the system 800 using a hybrid (HELD mode) method of communication. This method of communication may utilize the HELD system logic 700 depicted in FIG. 7. In this manner, dimming may occur using only the conduction angle. Other features may only be able to be changed through specially configured modes also utilizing OOK. Such embodiments may have the advantage of improved compatibility with existing dimmer switch devices and LLEs.

In HELD mode, the conduction angle may set the dimmer intensity, scaled by the minimum and maximum brilliances of the LLE (e.g., how bright and how dim the LLE may be set) and the minimum and maximum conduction angle of the dimmer (e.g., LLE Min and LLE Max). For example, the minimum dim conduction angle (LLE Min) of the dimmer may equal 0% brilliance of the LLE (e.g., LLE at minimum brightness) and the maximum dim conduction angle (LLE Max) of the dimmer may equal 100% brilliance of the LLE (e.g., LLE at maximum brightness).

Further, when the LLE (e.g., LLE system 800) is set to “off” the dimmer may still be configured to send energy to the LLE in order to keep the circuitry charged so the circuit does not require a surge of energy to charge the AC/DC rectifier circuit in the LLE when the LLE is changed to “on.” In the off state, power may be configured to not be delivered to the LEDs of the LLE and they will be off (e.g., no light will be produced). This state may correspond to the LLE OFF conduction angle. To turn the LLE on, the dimmer may send the minimum dim conduction angle (LLE min). As the user increases the dim level, the dimmer device may be configured to send new and increasing dim levels (and corresponding conduction angles) to the LLE. The LLE may then convert the conduction angle to a duty-cycle for dimming the LEDs of the LLE.

In some embodiments, the relationship between the duty cycle and conduction angle may be a percentage characterized by the following equation:

$$\frac{Conduction Angle}{Maximum Conduction Angle - Minimum Conduction Angle} \times 100$$

Using the percentage derived from the above equation, the LLE may use a look up table (LUT) (e.g., LUT stored on a memory of a controller 1002) that contains corrections for variances in LED constant current (dependent upon the power supply voltage) and non-linearities related to human perception of light (e.g., the dim level may be perceived to change at a lower rate at lower light levels and a higher rate at higher light levels). Such variance may include “flicker.” Based on the information in the LUT, the LLE may be configured to correct for the variances that are perceived in the LEDs based on the variances.

Using the LUT, the percentage derived may linearly correspond to a percentage of brightness for the lights (e.g., an angle percentage of 50% corresponds to the lights being 50% of their maximum brightness).

Embodiments for a system configured for WiFi performance and health heatmap generation are disclosed herein.

A method for displaying a heatmap of WiFi performance in an application (on memory of a controller 1002 with a processor) is disclosed. For example, any node may be used to generate such a heatmap of WiFi performance such as a recessed (recess-able) node configured to be substantially recessed in a wall. In another example, a modular backplate system (e.g., backplate with modular control unit as disclosed in U.S. Pat. No. 10,063,002, filed Mar. 18, 2016, which is herein incorporated by reference in its entirety) may be used to generate such a heatmap of WiFi performance. For example, a system with a backplate may be configured for WiFi access and the ability to measure WiFi signal strength at each node of a meshed WiFi network, which may be used to detect the strength of a WiFi signal at various locations in a building. The backplate (which may be a device control assembly) may be at any position (e.g., ceiling or wall) and be the backplate of any device (e.g., power outlet, light switch, and/or smoke detector). The application may be associated with any device (e.g., smartphone, tablet, or computer) that is connected to the WiFi network and has appropriate processing power to execute the algorithm.

When paired with a map of the building, the device (e.g., modular control device of a system) and an associated algorithm (e.g., AI module, heuristic code in Python, and/or the like) may create a heatmap of the WiFi signal at different locations in the building. This heatmap may be used to inform a user of WiFi signal strength at the different locations. Further, using the heatmap, program instructions stored on memory of the controller 1002 may be configured to recommend new mesh access points or wired access points to the user in order to increase coverage or strength of the WiFi signal. Similarly, the controller may be configured to-based on the heatmap—recom mend new WiFi hardware, or new or different locations for WiFi hardware to optimize the signal.

The controller may also be able to determine WiFi health throughout the building. For example, the controller may take into account metrics such as, but not limited to, signal strength (RSSI), bandwidth, and/or disconnect rates to determine what relatively good WiFi health (e.g., health that meets a threshold) is and what bad WiFi health is. In doing so, the controller may also take into account individual or the sum of reports from the different nodes, or measurement points in the building. Similar to WiFi signal strength, the controller may generate a heatmap 1100 of WiFi health throughout the building using such information/data. Based on the heatmap 1100, the controller may make suggestions or triangulate problem nodes in order to improve WiFi health. In another embodiment the controller may be configured to change settings, such as channel allocation, load sharing, or antenna transmit power, of the WiFi access point based on the heatmap, to improve WiFi Health.

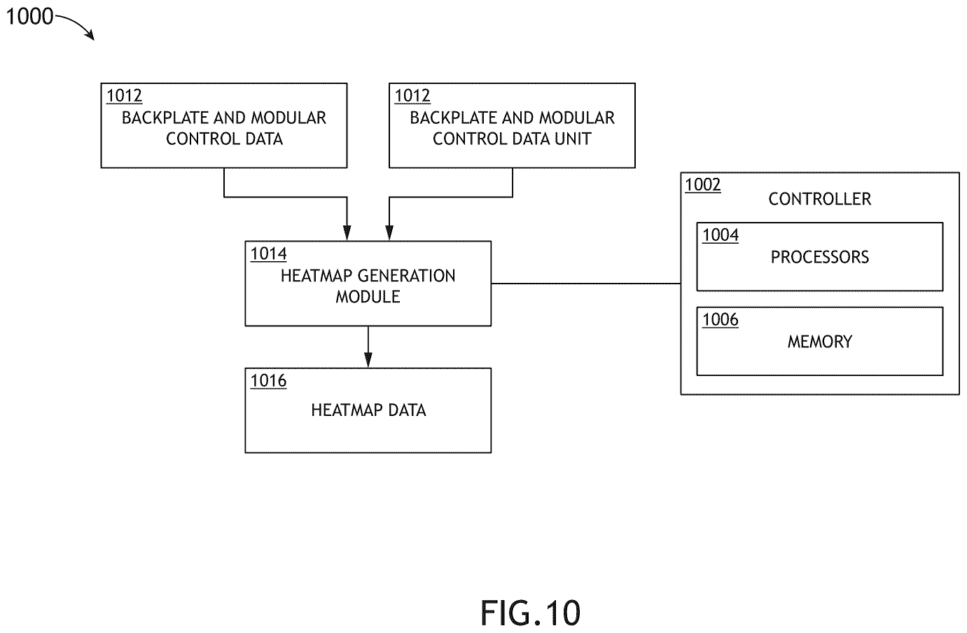

FIG. 10 illustrates a conceptual block diagram 1000 of a heatmap generation module 1014, in accordance with one or more embodiments of the present disclosure.

For example, a module (e.g., heatmap generation module 1014, artificial intelligence (AI) module, etc) may be program instructions stored on memory 1006 of a controller 1002, that when executed by the processor 1004 of the controller 1002, are configured to cause the controller 1002 perform one or more steps such as steps disclosed herein. The heatmap generation module 1014 (e.g., software application) may be configured to receive backplate and modular control data 1012 from one or more nodes (e.g., modular control units). The heatmap generation module 1014 may be configured to output heatmap data 1016 (e.g., signal upload speeds).

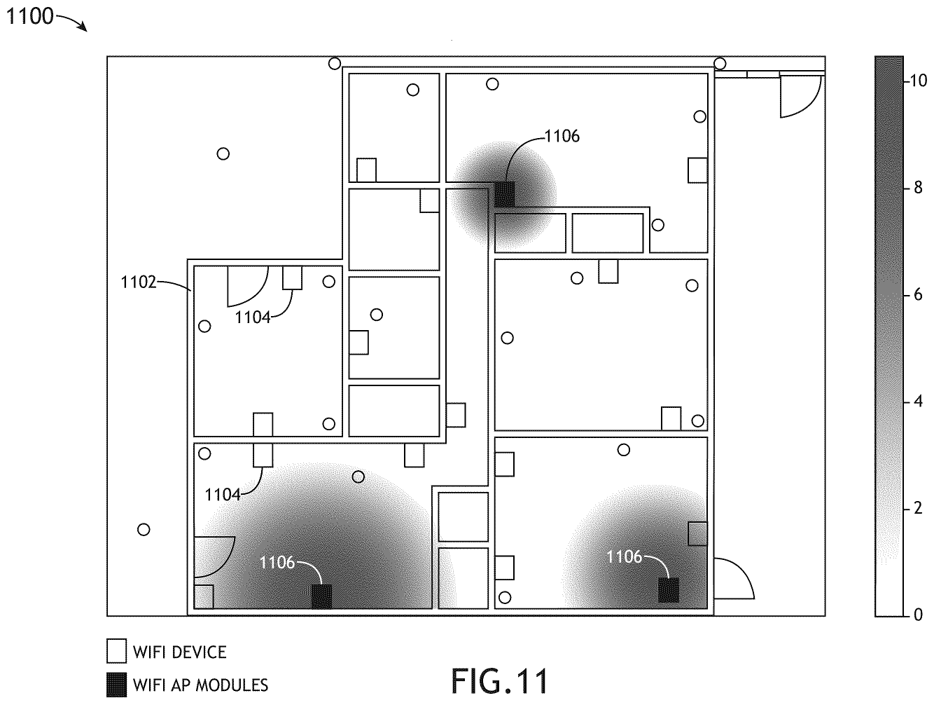

FIG. 11 illustrates an example heatmap 1100, such as may be generated based on the heatmap data 1016. Note that at least some of the elements shown in FIG. 11 such as specific dimensions of the floorplan and locations of access points may be taken from other sources, but used to illustrate certain concepts herein.

The heatmap 1100 may include heatmap data 1016 for signal upload speeds based on nodes 1106 (e.g., WiFi access point (AP) nodes 1106 such as WiFi routers emitted wireless WiFi signals). The nodes could include, but are not necessarily limited to, recessed/embedded nodes in a wall, modular control units (e.g., light switches, smart fan control modules, smart ceiling smoke alarms, and the like). In other words, modular controls units may be configured to be wireless signal access point nodes. For example, WiFi-enabled devices (e.g., nodes, modular control units 110, etc.) may measure signal strength using an RSSI portion of a standard WiFi packet. RSSI stands for Received Signal Strength Indicator (i.e., received signal strength), and measures how well a client device can hear (receive) a signal from where it is located. Using a received (e.g., downloaded from external source) floorplan 1102 of the house and the placement of the WiFi devices, a heatmap 1100 may be generated using, for example, an interpolation controller.

An interpolation controller may be any controller 1002 that is configured to interpolate a value between points based on the proximity to those points. For example, the interpolated value at a distance halfway between a signal strength of 5 for a first node and a signal strength of 10 for a second node would be a signal strength of 7.5 on the heatmap above if there were only two nodes. Linear interpolation may, for example, take two data points, say (xa,ya) and (xb,yb), and the interpolant is given by:

$$y = {y}_{a} + ( {y}_{b} - {y}_{a} ) \frac{x - {x}_{a}}{{x}_{b} - {x}_{a}} at the point ( x , y )$$

Examples of interpolation algorithms that may be used are bilinear or bicubic in 2 dimensions, trilinear in 3 dimensions, and/or the like.

The controller of the nodes (e.g., the WiFi access points 1106) may be configured to use the heatmap 1100 to determine the optimal channel and transmit power for improving the WiFi coverage in a home. For example, such determination may be performed using trial and error, or by analyzing gaps in coverage between two nodes 1106 and available transmit power capacity to fill those gaps. Additionally, the heatmap data 1016 may be configured to cause some devices (e.g., modular control units 110, 1104 that connect to WiFi but do not act as AP) to connect to under-used WiFi access points 1106 to more evenly distribute connections between access points 1106. The WiFi access points 1106 may be configured to use a metric to calculate the amount of capacity available to each access point and use that metric as a means to determine optimal distribution. The metric could be, but is not limited to, characterizations of the system such as a weighted average of the power consumption, data bandwidth, active connections, and/or processing capacity. The weights may be configured to be dynamically adjusted based on real performance using program instructions of the controller 1002.

By at least some definitions, RSSI and dBm are different units of measurement that both represent the same type of thing: signal strength. One difference is that RSSI is a relative index, while dBm is an absolute number representing power levels, typically in mW (milliwatts). RSSI may be a term used to measure the relative quality of a received signal to a client device, but typically has no absolute value.

Embodiments disclosing a system (e.g., a wireless power transmitter (WPTx)), such as for door locks and window blinds, are disclosed herein.

A wireless power transmitter (WPTx) is disclosed. The WPTx may be configured to transmit a low power output without wires or any other physical connection using any frequency (e.g., radio frequency (RF)).

Far field methods of wireless power transmission may achieve longer ranges, often multiple kilometer ranges, where the distance is much greater than the diameter of the device(s). High-directivity antennas or well-collimated laser light may produce a beam of energy that can be made to match the shape of the receiving area. The maximum directivity for antennas is physically limited by diffraction.

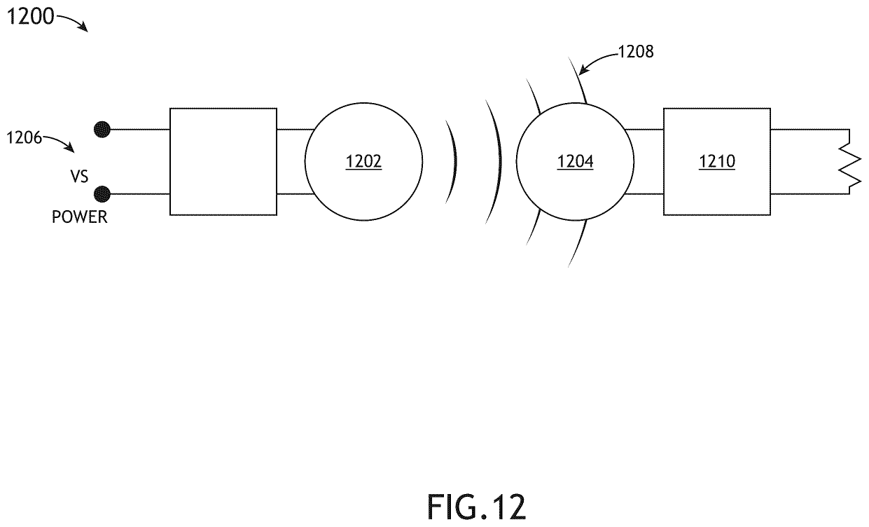

FIG. 12 illustrates a conceptual diagram of a wireless power transmitter (WPTx) 1200, which may be configured and/or include elements for door locks and window blinds.

The WPTx 1200 may include a power source 1206 and a transmitter 1202 coupled to the power source 1206. The transmitter 1202 may be configured to transmit power 1208. The WPTx 1200 may wirelessly transmit the power 1208 to a receiver 1204 of a load 1210 (e.g., anything that consumes electrical power such as devices that run on batteries) configured to receive the power 1208. The load 1210 may be any load, such as a backplate 130 of a modular control unit.

The WPTx 1200 may be integrated into any backplate 130. The backplate 130 may be at any position (e.g., ceiling or wall) and be the backplate 130 of any device (e.g., power outlet, light switch, or smoke detector). The WPTx 1200 may also include any wireless power transmitter 1202 sufficient to reach receiver devices 1204, such as, but not limited to a transmitter 1202 of a medium-field WPTx or a far-field WPTX.

For example, embodiments may include a WPTx of a modular control unit and/or backplate from U.S. Pat. No. 10,063,002, filed Mar. 18, 2016, which is herein incorporated by reference in its entirety.

The WPTx may provide a sufficient power supply to trickle charge batteries of compatible receiver devices (e.g., electric blinds, door locks, water leak detectors, or water valves). For example, the continuous flow of low power may be sufficient to continuously charge the batteries of the receiver devices. In this way, the batteries may not need to be charged via a physical connection or require any user interaction to be charged.

The receiver devices 1204, 1210 may include rechargeable batteries coupled to the receiver 1204 configured to be charged by the power 1208.

Further, the receiver devices 1204, 1210 (e.g., electric blinds, door locks, water leak detectors, or water valves) may be modified to increase the efficiency of the WPTx 1200. For example, the device housings may be configured in such a way to improve the effective are of the receiver devices' antennas 1204 (e.g., increase surface area or use a more conductive material).

The receiver devices 1204, 1210 may also be paired with a network of specific transmitters 1202. The specific transmitters may be chosen in a manner that maximizes the power transmitted to all of the receiver devices 1204, 1210, such as by pairing transmitters 1202 to the closest receiver device 1204, 1210. In this way, receiver devices 1204, 1210 may communicate to a specific transmitter 1202 or group of transmitters. This may allow a specific receiver device 1204, 1210 to communicate that it is fully charged to its network of transmitters 1202, without interrupting the power 1208 transmitted to other receiver devices from different networks of transmitters. This may also allow a transmitter 1202 to target a different receiver device 1204, 1210.

Embodiments for systems configured for switch configuration election and automatic home features using artificial intelligence are disclosed herein.

An artificial intelligence (AI) method for optimizing user configurable building features is disclosed.

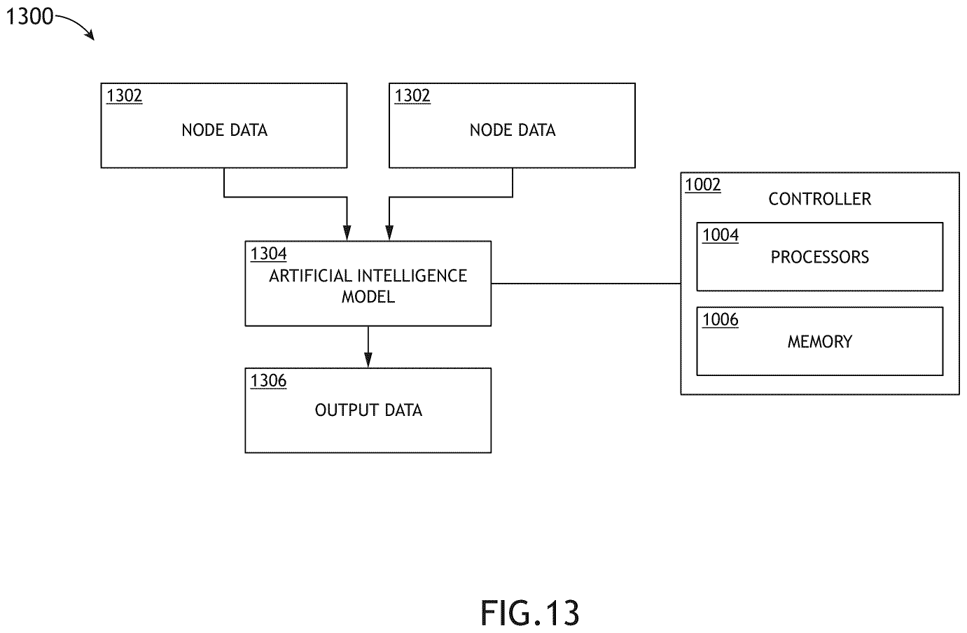

FIG. 13 illustrates a conceptual block diagram 1300 of an artificial intelligence (AI) module 1304, in accordance with one or more embodiments of the present disclosure.

As noted, a module may be program instructions stored on memory 1006 of a controller 1002.

In some embodiments, node data 1302 may be used to configure the nodes (e.g., modular control units, backplates, and/or the like) and/or a network of the nodes using an artificial intelligence module 1304 (e.g., machine learning module). Any artificial intelligence module 1304 may be used. For example, a transformer architecture of neural networks may be used, as is used in natural language processing in the industry. In other examples, a convolutional neural network (CNN), recurrent neural network (RNN), artificial neural network (ANN), and/or the like may be used. The artificial intelligence module 1304 may be configured, based on weights in the neural network, to output some output data 1306.

A node may be any node. For example, a node may include a controller 1002 and be capable of communicating (e.g., via wireless or wired communications) to other nodes.

For instance, a node may be a component configured to be recessed in a wall (e.g., sheetrock wall). For example, a node may be a component “embedded” or configured to be embedded or substantially recessed relative to a wall.

In an alternative nonlimiting instance, or additionally, a node may include, but is not limited to, a modular control unit and/or backplate from U.S. Pat. No. 10,063,002, filed Mar. 18, 2016, which is hereby incorporated by reference in its entirety. For example, a node could be a (smart, wireless-enabled) light switch, smoke detector, outlet, or the like.

In some embodiments, once a node is named (e.g., named by a user) on a user's profile, a controller 1002 may be configured to use node data 1302 of various nodes to, for example, suggest additional nodes for the node to be connected to or utilize. For example, node data 1302 may include the type of node/switch (e.g., model number, compatibility codes, descriptor data (e.g., identified as a light switch), and the like) and/or what the node is named, in combination with names and types of other nodes/switches. For example, a node named “theater lights ceiling” may be configured to be categorized with other similarly named nodes (e.g., “movie room Smart shades” that are actuatable electronically). For example, the output data 1306 may be indicative that those two names are “correlated” to such a degree (e.g., above a certain threshold of confidence of the AI module, e.g., 50%) that the AI module may be further configured, based on the threshold, to suggest to a user that the newly added “theater lighting module” should be grouped together with the “movie room Smart shades” in a new (or existing) “theater” group. Benefits of such automatic grouping may be that various nodes are quickly accessible on a screen of a command module configured to control multiple operations of various nodes. For example, the system may include a user interface (graphical user interface) usable by a user to control all nodes in a category at the same time (simultaneously) and/or group the nodes so they can be quickly adjusted individually without having to search through a relatively longer list of all possible nodes (e.g., including nodes not part of a “theater” group).

For example, training data for the AI module 1304 may be used to train the AI module 1304 to determine whether two nodes should be grouped. For example, the training data may be a set of groups of names that should (or shouldn't) be grouped such that the AI module, via a training process, learns to determine an output of whether two nodes should be grouped (or suggested to a user to be grouped).

In embodiments, in regards to the AI module 1304, the training inputs are at least one of node names, node locations, node categories, occupancy data, node device types, in-profile usage of a node, user programmed features, geographical location of the home, the time after setup of a new node or feature, type of user doing the setup of a system (e.g. first-time homeowner, experienced smart home user, professional smart home installer, etc.), seasonal shifts (e.g., time of year such as date of December meaning winter and the like), and/or node zone location (e.g., room, basement, garage, pool table area, and the like); and/or the training outputs are at least one of schedules, timers, categories, and/or node network/layout configurations (e.g., which nodes control which other nodes such as which speakers belong to which sound systems, which lights belong to which light controlling nodes, which window shades are associated with which windows/rooms in a layout map of a building/area, which sensors are associated with which nodes and the like). The training inputs may be collected from a distributed set of homes throughout a geographic region, for example a country, state, county or city area. The training inputs may be limited to experienced or professional users to provide a pseudo-supervised training data.

Node data 1302 may include, but is not limited to, names, zones (e.g., grouping of nodes in similar areas), scenes (e.g., grouping of similar nodes), schedules, timers, and the like. The AI module 1304 may be configured to make suggestions 1306 (e.g., suggested improvements 1306) to a user based on node data 1302 such as, but not limited to, in-profile usage, seasonal shifts, occupancy data, device type, and the like.

For example, an AI module 1304 may be trained to suggest (to a user) that a node named “John's Smart outlet” should be programmed to be turned on when the system 1300, via occupancy detection, detects that John is in the same room that the node is in. For example, a coffee maker plugged into a modular control unit's or backplate's 130 receptacle (e.g., 3-prong female wall outlet) may be turned on in the morning when it is determined that John walks into the room (e.g., kitchen).

Large datasets may be generated to train one or more AI module 1304 to make various types of output data 1306 decisions/suggestions associated with the nodes, such as output data 1306 indicative (or configured to) group nodes, actuate/control/power-on/power-off nodes, gather sensor data of nodes (e.g., search for occupants using Bluetooth signal data and antennas), and/or the like.

The AI system 1300 may include one or more memories 1006 suitable for storing user profile history and an AI algorithm, communicatively coupled to one or more processors 1004 suitable for executing the AI algorithm. Further, the processor 1004 and memory 1006 may be communicatively coupled to a user interface (e.g., display) (not shown) that displays suggestions from the algorithm and allows a user to input information (e.g., via a touchscreen display) and make selections.

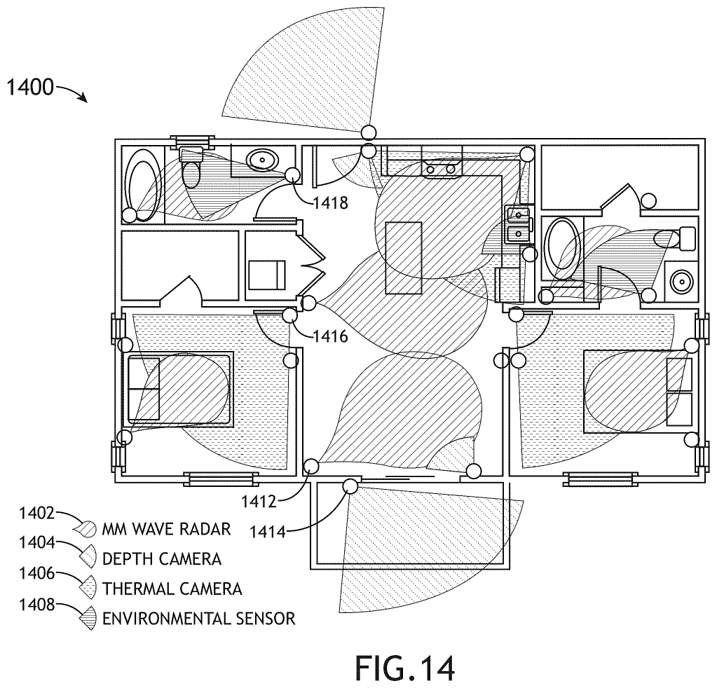

FIG. 14 illustrates a floorplan view of a system 1400 including sensors 1412, 1414, 1416, 1418 configured for automation, in accordance with one or more embodiments of the present disclosure. The system 1400 may include the system 1300 or elements, steps, and/or the like thereof, or vice versa. Any embodiments herein may likewise include elements, steps, and/or the like thereof of any other embodiments.

The AI system 1400 may be configured to employ/utilize smart home controls and various available sensors to perform actions that make an ambient home experience.

The AI system 1400 may be configured to remember (e.g., store on a memory 1006) a user's behavior and track it using motion sensing (e.g., passive infrared (PIR) motion sensors, ultrasonic sensors, radar, camera, thermopile array, and the like) and automatically activate smart home features to control/actuate one or more networked nodes. For example, the system 1400 may be configured to open smart blinds motorized with a motor and turn on lights when the sensor(s) receive information (e.g., radar returns, imagery, etc.) indicative that a user has woken up in the morning. For example, a signal (e.g., motion sensor PIR signal, radar 1412, etc.) above a selectable threshold obtained from a sensor in the bedroom, hallway, kitchen, or the like may be used to decide via program instructions of a controller 1002 stored on memory 1006 that a user is awake. Such a determination may also be based on the time of day and/or day of the week (e.g., an awaken determination may be based on such a threshold breach occurring, for example, for the first time between the hours of 3:00 am to 11:00 am on a weekday).

In embodiments, the system includes sensors, which may be (or include) a mmWave radar 1412. Such a radar may be used for, but is not limited to multi-occupant detection and tracking, vital sign measurements (heart and breath), fall detection, and/or gesture detection for controlling living space features such as the heads-up display or the lights in a room.

In embodiments, the system includes sensors 1412, 1414, 1416, 1418, which may be (or include) a depth perception camera 1414 using image sensors+LIDAR or Time of Flight (TOF) cameras for face identification, person detection, automatic security, and the like.

In embodiments, the system includes sensors, which may be (or include) a thermal camera 1416 for fire detection, personal health tracking, and HVAC optimization (heating and cooling).

In embodiments, the system includes sensors, which may be (or include) environmental (temp, humidity, stink) sensors 1418 for HVAC control optimization (ventilation in bathroom, targeted heating and cooling.

In embodiments, the system includes sensors, which may be (or include) a Digital Light Processing (DLP) for projecting images anywhere—heads up display wherever you are—e.g., play videos (e.g., YouTube) such as recipes in the kitchen, which may be controlled (e.g., paused) with a gesture.

The AI system 1400 may be configured (e.g., via program instructions of a controller 1002) to disarm the security system when a recognized user is, for example, entering the home as sensed by a sensor (e.g., a depth-perception camera 1404—a camera equipped with TOF or LIDAR, or pseudo-LIDAR algorithms applied to image-based optical cameras in the visible spectrum and/or facial recognition algorithms applied to sensors such as conventional visible light cameras). The AI system 1400 may further be configured to remember the ID′d person (e.g., based on the facial recognition using cameras and a stored database of IDs and associated ID preferences/data) and be configured to make personalized decisions based on the ID of the person and the location of the person as the person moves about the home/building. For example, a visual user interface on a phone, tablet, screen installed in a wall of the building, or the like; and/or an auditory speaker and microphone (e.g., personal assistant-like system) may be used to suggest one or more configurations/controls (e.g., turn on an appliance, dim the lights, play a playlist when a user walks in a workout room, and the like) to a user and, based on user feedback (e.g., confirmation button selected on a GUI of a touchscreen, auditory confirmation by the user sensed by a coupled microphone, etc.) perform such a configuration/control.

The AI system 1400 may be configured to measure vital signs (e.g., heart-rate and/or breath rate via 3D radar sensing using a mm wave radar 1402) of a person in the bed and perform sleep tracking for a user. The sleep tracking may further be used to monitor the user's health and alert the user to a sleep score or potential health warnings. The sleep tracker may further be used to monitor when a person enters an optimal stage of sleep for waking up and creating a dynamic alarm to gracefully waking the person up.

The AI system 1400 may be configured to measure the heat throughout a home using thermopile array (heat) sensors 1406 that can be used as an early alert to a fire, an appliance being left on or energy-wasting gadget that should be unplugged. Further using the heat sensors, user preference, in addition to environmental sensors—VOC, CO2, Humidity, etc to control the HVAC system in each room of the home (ventilation, targeted heating and cooling, etc).

Further, the AI system 1400 may be configured to aggregate data from the neighborhood and, for example, the city or other cities to improve the training set for the AI system 1400 by coupling data 1302 from homes with similar floorplans, number of occupants, demographics, and/or climates. Further, the aggregated data may be used to suggest energy savings to home occupants such as by using known (aggregated) or simulated (e.g., interpolated) data of occupancy rates for buildings/homes and/or rooms of those buildings to suggest thermostat settings for such homes/rooms. For example, thermostat preference data of similar floorplan/sized homes in similar climates may be used (e.g., to train a machine learning model or to suggest to homes in the same neighborhood using heuristic code) to suggest to other homes the same/similar thermostat preferences (e.g., suggested thermostat preference data). In some embodiments the data is aggregated (e.g., to share with utility companies in the corresponding jurisdictions) to show overall usage trends.

The (AI) system 1400 may include (and be configured to detect if a person falls using) 3D radar sensors, camera sensing, microphones, and/or vibration sensors. Further, based on such a fall detection, the AI system 1400 may be configured to alert family or local authorities to check on the user.

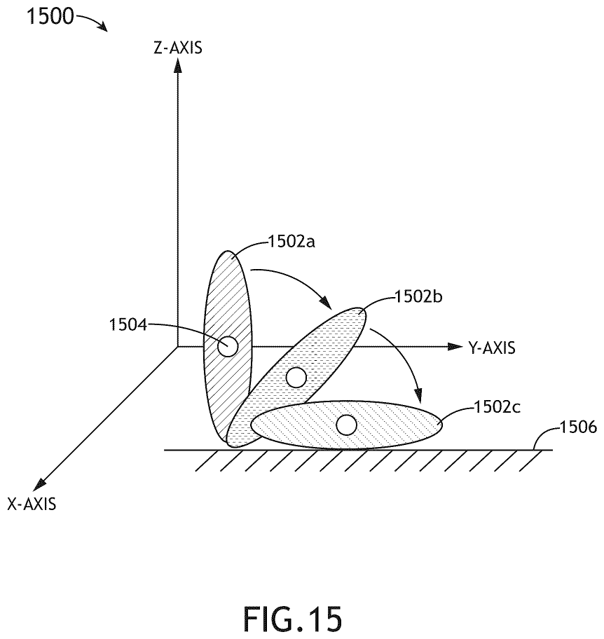

FIG. 15 illustrates a conceptual view of a person 1502 (e.g., person at a first position 1502a) falling to the ground 1506, in accordance with one or more embodiments of the present disclosure.

The system 1400 may be configured for fall detection of a person in three positions 1502a, 1502b, 1502c, over time (e.g., using 3D radar sensors (e.g., sensor 1402) or any other sensor).

In embodiments, if the rotation speed, range of rotation, and location of a person meets a criteria/threshold, then a fall may be configured to be determined/detected. For example, if a body is standing and falls within a certain period of time and/or within a threshold of angle/translation, then a fall may be detected. For example, a standing position 1502a may be detected by a camera. For instance, a vertical torso (or body) to within plus or minus 10 degrees of Z-axis (e.g., as defined by gravity, angle of camera, etc.)) as shown by body position 1502a may be configured to be detected. Further, in addition or alternatively (for purposes of detecting a fall), a rotation may be detected that breaches a threshold. For instance, a rotation of the torso (or body) more than a threshold angle (e.g., 10, 20, 30, 40, 50, 60, 70, 80, 90, 100 degrees, or the like or more) is measured and may be determined to be indicative of a fall. Further, in addition or alternatively (for purposes of detecting a fall), a translation (e.g., lowering) may be detected that breaches a lowering threshold. For example, a center 1504 of a person (e.g., dot in figure, center of mass, centroid of torso or body, and/or the like) may be used to track a “lowering” relative to a direction (e.g., gravity, vertical direction of image, and the like). For instance, a lowering of the torso (or body) more than a threshold distance (e.g., 1 foot, 2 feet, . . . ; 10, 50, 100 pixels; 10, 20, 30 percent of the starting distance of the centroid to the floor from when standing; and/or the like) is measured and may be indicative of a fall. In some embodiments, such a rotation and/or lowering must occur within a certain period of time and/or by a certain user to be determined a fall. For example, an elderly user ID associated with a user tracked in a video may be used to track whether the elderly user ever rotates and/or lowers their body more than the thresholds within a period of time (e.g., 0.3, 0.5, 1, 2, 3, 4, 5, 6, 7, 8 seconds and/or the like). For instance, a rotation of 40 degrees of a torso combined with a lowering of more than 1 foot of a sensed hip area of a body and/or centroid being within 2 feet of the floor and occurring within 3 seconds may trigger a “fall” detection for a specific user tracked with an ID. In some examples, a speed of movement over time is enough to detect a fall, such as by using radar sensor 1412. For example, a fall detection may be based on an exponential increase in speed followed by a sudden stop, which may be indicative of gravity speeding up a torso and the stop may be indicative of a collision with the ground 1506. Note such examples and the like are nonlimiting and other fall detects may be made such as based on a (trained) AI model module 1304 trained on video data to detect a fall.

The one or more processors 1004 of controller 1002 may include any one or more processing elements known in the art. In this sense, the one or more processors 1004 may include any microprocessor device configured to execute algorithms and/or instructions. In one embodiment, the one or more processors 1004 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium (e.g., memory 1006). Moreover, different subsystems of the system 100 (e.g., any system herein such as system 1400) may include processor or logic elements suitable for carrying out at least a portion of the steps described throughout the present disclosure. Therefore, the above description should not be interpreted as a limitation on the present invention but merely an illustration.

The memory medium 1006 may include any storage medium known in the art suitable for storing program instructions executable by the associated one or more processors 1004. For example, the memory medium 1006 may include a non-transitory memory medium. For instance, the memory medium 1006 may include, but is not limited to, a read-only memory, a random access memory, a magnetic or optical memory device (e.g., disk), a magnetic tape, a solid state drive and the like. In another embodiment, it is noted herein that the memory 1006 is configured to store one or more results from the system 100 and/or the output of the various steps described herein. It is further noted that memory 1006 may be housed in a common controller housing with the one or more processors 1004. In an alternative embodiment, the memory 1006 may be located remotely with respect to the physical location of the processors and controller 1002. For instance, the one or more processors 1004 of controller 1002 may access a remote memory (e.g., server), accessible through a network (e.g., internet, intranet and the like). In another embodiment, the memory medium 1006 stores the program instructions for causing the one or more processors 1004 to carry out the various steps described through the present disclosure.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

In another embodiment, the controller 1002 of the system 100 may be configured to receive and/or acquire data or information from other systems by a transmission medium that may include wireline and/or wireless portions. In another embodiment, the controller 1002 of the system 100 may be configured to transmit data or information (e.g., the output of one or more processes disclosed herein) to one or more systems or sub-systems by a transmission medium that may include wireline and/or wireless portions. In this manner, the transmission medium may serve as a data link between the controller 1002 and other subsystems of the system 100. Moreover, the controller 1002 may send data to external systems via a transmission medium (e.g., network connection).

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system configured for swappable wiring configurations, comprising:
a backplate comprising:
a first assembly configured to be fastened to a junction box; and
a removably couplable cup portion configured to be removably couplable to the first assembly and configured to electrically couple to wires of the junction box, the removably couplable cup portion comprising:
a recess that includes a set of backplate electrical contacts,
wherein the backplate is configured to be removably coupled to at least one device control assembly, the at least one device control assembly comprising a set of device control assembly electrical contacts configured to electrically couple with the set of backplate electrical contacts of the backplate when the at least one device control assembly is coupled to the backplate and configured to electrically decouple from the set of backplate electrical contacts when the at least one device control assembly is decoupled from the backplate.

2. The system of claim 1, wherein the electrical coupling of the removably couplable cup portion to the wires of the junction box is configured to be performed via a set of wiring electrical contacts on a wall-facing side of the removably couplable cup portion.

3. The system of claim 2, wherein the set of wiring electrical contacts of the removably couplable cup portion are configured for one of: a 1-way switch, a 3-way switch, or a 4-way switch.

4. The system of claim 1, wherein the first assembly comprises a backplate housing, wherein the first assembly is configured to be fastened to the junction box via the backplate housing.

5. The system of claim 1, wherein the first assembly comprises a grounding bus element comprising electrically conductive material.

6. The system of claim 5, wherein the grounding bus element is configured to electrically ground the removably couplable cup portion.

7. The system of claim 5, wherein the grounding bus element comprises bus coupling features allowing for a sequential attachment of additional backplates, enabling a linear arrangement of the backplate and the additional backplates with continuous electrical coupling.

8. The system of claim 7, wherein the grounding bus element comprises a first bus bar at an upper end and a second bus bar at a lower end of the grounding bus element, wherein locations of the bus coupling features comprise lateral distal side ends of the first bus bar and the second bus bar to allow for a lateral and linear sequential attachment of the additional backplates.

9. A removably couplable cup portion comprising:
a cup housing defining a recess; and
the recess that includes a set of backplate electrical contacts,
wherein the removably couplable cup portion is configured to be electrically coupled to wires of a junction box via wiring electrical contacts;
wherein the removably couplable cup portion is configured to be removably coupled to at least one device control assembly, the at least one device control assembly comprising a set of device control assembly electrical contacts configured to electrically couple with the set of backplate electrical contacts of the removably couplable cup portion when the at least one device control assembly is coupled to the removably couplable cup portion and configured to electrically decouple from the set of backplate electrical contacts when the at least one device control assembly is decoupled from the removably couplable cup portion.

10. The removably couplable cup portion of claim 9, wherein the cup housing is cup-shaped.

11. The removably couplable cup portion of 9, wherein the wiring electrical contacts of the removably couplable cup portion are configured for one of: a 1-way switch, a 3-way switch, or a 4-way switch.

12. The removably couplable cup portion of claim 9, wherein the removably couplable cup portion is configured to be fastened to a backplate housing via removably couplable features.

13. A logic system for an LED light engine (LLE), comprising:
a dimmer device; and
a logic circuit for the LLE configured to be electrically coupled to the dimmer device, wherein the logic circuit comprises a decoder configured to decode waveforms received from the dimmer device based on a plurality of nonzero conduction angles of the waveforms, wherein the logic circuit is configured to determine a compatibility of the dimmer device based on the nonzero conduction angles.

14. The logic system of claim 1, further comprising an AC/DC rectifier, a logic processing component, a constant-current driver circuit, and a plurality of LEDs.

15. The logic system of claim 1, wherein the waveforms comprise an encoded message detailing functions of the dimmer device.

16. The logic system of claim 1, wherein the determining the compatibility of the dimmer device is configured to occur at a time on period of the logic system.

17. The logic system of claim 1, wherein the plurality of nonzero conduction angles comprises: an LLE OFF conduction angle, an LLE Min conduction angle, an LLE Max conduction angle, an OOK High conduction angle, and an OOK Low conduction angle.

18. A method for displaying a WiFi heatmap of a WiFi system, comprising:
detecting metrics of a WiFi signal at a plurality of locations in a building via a plurality of device control assemblies, wherein the plurality of device control assemblies are configured to connect to a WiFi network and receive measurements of the WiFi signal;
generating the WiFi heatmap and improvements to the WiFi system via a heatmap generation module configured to use the measurements;
displaying the WiFi heatmap to a user; and
suggesting the improvements to the WiFi system.

19. The method of claim 18, wherein each of the plurality of device control assemblies are one of: a light switch device control assemblies, a smoke detector device control assemblies, or a power outlet device control assemblies.

20. The method of claim 18, wherein the WiFi system comprises a mesh WiFi system.

21. The method of claim 18, wherein the metrics taken into account by the heatmap generation module are at least one of: signal strength, bandwidth, or disconnect rate.

22. The method of claim 18, wherein the suggesting improvements is at least one of: suggesting new access point locations, suggesting new locations for WiFi enabled nodes, suggesting new WiFi enabled nodes, or suggesting optimal locations for the WiFi enabled nodes, wherein the WiFi enabled nodes comprise at least one of WiFi access point nodes.

23. The method of claim 18, wherein the improvements are implemented in the WiFi system by commands sent by the device control assembly.

24. A system, comprising:
one or more receiver devices; and
one or more wireless power transmitters (WPTx), wherein the one or more WPTx are configured to trickle charge the one or more receiver devices via transmitted power.

25. The system of claim 24, wherein the one or more receiver devices are powered by rechargeable batteries.

26. The system of claim 24, wherein each of the one or more WPTx are one of: a medium-field WPTX or a far-field WPTX.

27. The system of claim 24, wherein each of the one or more receiver devices are paired to a network.

28. The system of claim 24, wherein each of the one or more receiver devices communicate to one or more WPTx.

29. The system of claim 24, wherein the one or more WPTx are located in one or more modular control units of a mesh network.

30. An artificial intelligence method, comprising:
storing historical profile data and an artificial intelligence (AI) module in a memory;
detecting smart device installations; and
suggesting improvements to a smart-home set up based on the smart device installations.

31. The artificial intelligence method of claim 30, wherein the AI module is configured to generate the suggested improvements based on at least one of: in-profile usage, seasonal shifts, occupancy data, or device type.

32. The artificial intelligence method of claim 30, wherein the AI module is configured to generate the suggested improvements including at least one of: device names, device zones, device scenes, schedules, or timers.

33. A system comprising:
a controller communicatively coupled to the system, the controller including one or more processors configured to execute program instructions causing the one or more processors to:
receive a machine learning module;
receive node data of one or more nodes; and
generate, using the machine learning module and the node data, output data indicative of at least one of:
a configuration of one of the one or more nodes;
a user suggestion for one of the one or more nodes; or
a category for one of the one or more nodes.

34. The system of claim 33, the controller further configured to generate the machine learning module based on training data configured to correlate training inputs to training outputs of the training data.

35. The system of claim 34, wherein the training inputs include nodes names and the training outputs include a value indicative of whether a node name belongs to one or more categories.

36. The system of claim 34, wherein the training inputs include at least one of node names, node locations, node categories, occupancy data, node device types, in-profile usage of a node, seasonal shifts, or node zone locations.

37. The system of claim 34, wherein the training outputs include at least one of schedules, timers, categories, or node network layout configurations.
